(19) United States
(12) Patent Application Publication
(10) Pub. No.: US 2026/0111358 A1
(43) Pub. Date: Apr. 23, 2026

(54) METHODS AND APPARATUS TO UPDATE FIRMWARE USING BULK REGISTER ACCESS

(71) Applicant: Texas Instruments Incorporated, Dallas, TX (US)

(72) Inventors: Atul Kumar Agrawal, Bangalore (IN); Nikhil Goyal, Bangalore (IN); Aditya Polepeddi, Bangalore (IN); Gaurav Rana, New Delhi (IN)

(21) Appl. No.: 19/254,863

(22) Filed: Jun. 30, 2025

(30) Foreign Application Priority Data
Oct. 23, 2024 (IN) 202441080769

(51) Int. Cl. G06F 12/02; G06F 9/30; G06F 11/10; G06F 13/40; G06F 13/42

(52) U.S. Cl. CPC G06F 12/0246; G06F 9/3013; G06F 11/1004; G06F 13/4027; G06F 13/4282

(57) ABSTRACT

A device includes: a first memory corresponding to a first range of memory addresses, and a second memory corresponding to a second range of memory addresses, where the first range of memory addresses are non-consecutive to the second range of memory addresses; and a controller configured to: request first data; after requesting the first data, receive the first data in a packet having a first data set and a second data set, the first data set including a first chunk start address corresponding to an address of the first range of memory addresses, the second data set including a second chunk start address corresponding to an address of the second range of memory address; write data of the first data set to the first memory using the first chunk start address; and write data of the second data set to the second memory using the second chunk start address.

### CROSS-REFERENCE TO RELATED APPLICATION

This patent application claims the benefit of and priority to Indian Provisional Patent Application No. 202441080769 filed Oct. 23, 2024, which is hereby incorporated herein by reference in its entirety.

### TECHNICAL FIELD

The present disclosure relates generally to an electronic system and method, and, in particular embodiments, to methods and apparatus to update firmware using bulk register access.

### BACKGROUND

Firmware provides digital systems with an instruction set representing different operations. Digital systems execute a series of instructions to implement, e.g., relatively complex operations. Some digital systems support firmware updates via a communication interface with a host device. During a firmware update, a host device provides a digital system with configuration data containing the firmware update. The digital system completes the firmware update by writing the firmware update to chunks of memory corresponding to the firmware. Devices supporting firmware updates allow designers to fix bugs, add features, etc.

### SUMMARY

In accordance to an embodiment, a device includes: memory circuitry having a first memory portion and a second memory portion, the first memory portion corresponding to a first range of memory addresses, the second memory portion corresponding to a second range of memory addresses, where the first range of memory addresses are non-consecutive to the second range of memory addresses; and a controller coupled to the memory circuitry, the controller configured to: request first data; after requesting the first data, receive the first data in a packet having a first data set and a second data set, the first data set including a first chunk start address corresponding to an address of the first range of memory addresses, the second data set including a second chunk start address corresponding to an address of the second range of memory address; write data of the first data set to the first memory portion using the first chunk start address; and write data of the second data set to the second memory portion using the second chunk start address.

In accordance to an embodiment, a method includes: requesting, by a first device, first data using a first protocol; after requesting the first data, receiving, by the first device, a packet including the first data using the first protocol, the first data having a first data set and a second data set, the first data set including peripheral data, the second data set including a chunk start address corresponding to an address of a first portion of memory; writing, by the first device, a first portion of the first data set to a second portion of memory; after writing the first portion of the first data set, providing, by the first device, the peripheral data to a second device using a second protocol; after writing the first portion of the first data set, writing, by the first device, a second portion of the first data set to the second portion of memory; and after writing the second portion of the first data set, writing data of the second data set to the first portion of memory using the chunk start address of the second data set.

In accordance to an embodiment, a device includes: memory circuitry having a first memory portion, a second memory portion, and a third memory portion, the first memory portion corresponding to a first range of memory addresses, the second memory portion corresponding to a second range of memory addresses, the third memory portion corresponding to a third range of memory addresses, where the first and second ranges of memory addresses are consecutive addresses, and where the second and third ranges of memory addresses are consecutive addresses; and a controller coupled to the memory circuitry, the controller configured to: request configuration data; after requesting the configuration data, receive the configuration data having a first data set and a second data set, the first data set including a first memory address in the first range of memory addresses, the second data set including a second memory address of in the third range of memory addresses; write data of the first data set to the first memory portion using the first memory address; and write data of the second data set to the third memory portion using the second memory address.

In accordance to an embodiment, an electronic device includes: a primary device; a secondary device; and an audio device coupled to the primary device and the secondary device, the audio device configured to: receive an update using a first communication protocol, the update having a first data set and a second data set, the update corresponding to operations of the secondary device; write data of the first data set to a first portion of memory, the first portion of memory corresponding to first operations of the secondary device; and write data of the second data set to a second portion of memory, the second portion of memory corresponding to second operations of the secondary device, the first and second portions of memory have non-consecutive memory addresses.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a block diagram of an example audio system including file download (FDL) circuitry and FDL decoder circuitry to update firmware from configuration data including a firmware update, according to an embodiment of the present disclosure;

FIG. 2 is a block diagram of an example of the configuration data of FIG. 1 including a firmware update, according to an embodiment of the present disclosure;

FIG. 3 is a timing diagram of example operations of the FDL decoder circuitry of FIG. 1 to update firmware in memory, according to an embodiment of the present disclosure;

FIG. 4 is a block diagram of an example of the FDL circuitry of FIG. 1, according to an embodiment of the present disclosure;

FIG. 5 is a block diagram of an example of the FDL decoder circuitry of FIG. 1, according to an embodiment of the present disclosure

FIG. 6 is a flowchart representative of example machine-readable instructions or example operations that may be at least one of executed, instantiated, or performed using an example implementation of the FDL circuitry of FIGS. 1 and 4 and the FDL decoder circuitry of FIGS. 1 and 5 to update the firmware of the audio system of FIG. 1 using the configuration data of FIGS. 1 and 2, according to an embodiment of the present disclosure;

FIG. 7 is a block diagram of another example of the configuration data of FIGS. 1 and 2 for a firmware update including cyclic redundancy checks (CRCs), according to an embodiment of the present disclosure;

FIG. 8 is a flowchart representative of example machine-readable instructions or example operations that may be at least one of executed, instantiated, or performed using an example implementation of the FDL circuitry of FIGS. 1 and 4 and the FDL decoder circuitry of FIGS. 1 and 5 to update the firmware of the audio system of FIG. 1 using the configuration data of FIG. 7, according to an embodiment of the present disclosure;

FIG. 9 is a block diagram of another example of the configuration data of FIGS. 1, 2, and 7 for a firmware update including peripheral device writes, according to an embodiment of the present disclosure;

FIGS. 10A and 10B are a timing diagram of example operations of the FDL decoder circuitry of FIGS. 1 and 5 to update firmware in memory circuitry using the configuration data of FIG. 9, according to an embodiment of the present disclosure;

FIG. 11 is a flowchart representative of example machine-readable instructions or example operations that may be at least one of executed, instantiated, or performed using an example implementation of the FDL circuitry of FIGS. 1 and 4 and the FDL decoder circuitry of FIGS. 1 and 5 to update the firmware of the audio system of FIG. 1 using the configuration data of FIG. 9, according to an embodiment of the present disclosure;

FIG. 12 is a block diagram of an example processing platform including programmable circuitry structured to execute, instantiate, or perform the example machine-readable instructions or perform the example operations of FIGS. 6, 8, and 11 to implement the FDL circuitry and the FDL decoder circuitry of FIGS. 1, 4, and 5.

FIG. 13 is a block diagram of an example implementation of the programmable circuitry of FIG. 12, according to an embodiment of the present disclosure; and FIG. 14 is a block diagram of another example implementation of the programmable circuitry of FIG. 12.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In some cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

Firmware provides digital systems with an instruction set representing different operations. Digital systems execute a series of instructions to implement, e.g., relatively complex operations. Some digital systems support firmware updates via a communication interface with a host device. During a firmware update, a host device provides a digital system with configuration data containing the firmware update. The digital system completes the firmware update by writing the firmware update to chunks of memory corresponding to the firmware. Devices supporting firmware updates allow designers to fix bugs, add features, etc.

In some systems, device manufacturers provide firmware updates to devices in the form of a file or file set containing configuration data (also referred to as update data). An updating device begins the firmware update process by receiving access to the configuration data. In some examples, the updating device uses a file download (FDL) process to receive the configuration data from a host device. For example, some devices use an over-the-air (OTA) connection to an FDL server or device to receive the configuration data. In other examples, the updating device uses a direct connection to a host device, which stores the file or file set containing the configuration data. The updating device uses a communication protocol to receive the configuration data via a data stream from the host device. Some communication protocols, such as SoundWire, provide the configuration data using a process of bulk register access (BRA). BRA is a process of providing the configuration data responsive to one or more BRA call commands (BRA_CALL) from the updating device. A BRA call command (BRA_CALL) is a request from the updating device to receive access to a file containing the configuration data. In some examples, such as firmware updates using configuration data from a set of files, the updating device generates a series of BRA call commands (BRA_CALL) to access configuration data in each file of the file set.

In operation, the updating device stores the original firmware image in chunks of memory (also referred to as portions of memory). A chunk of memory is a set of consecutive memory addresses corresponding to a given function of the firmware image. After determining the host device has a file to update the firmware in one or more chunks of memory, the device generates a BRA call command (BRA_CALL) to update the portion of the firmware image in a first chunk of memory. The BRA call command (BRA_CALL) identifies a file in the host device to provide to the device. The host device generates a BRA data stream (BRA_DATA) to provide the configuration data of the file responsive to the BRA call command (BRA_CALL). The BRA data stream (BRA_DATA) provides the updating device access to the configuration data.

The updating device updates the firmware by writing portions of the configuration data to consecutive addresses of the corresponding chunk of memory. However, if the firmware update includes configuration data corresponding to non-consecutive memory addresses, such as in non-consecutive chunks of memory, the updating device has to generate another BRA call command (BRA_CALL) to receive the next portion of the update. The additional BRA call command(s) (BRA_CALL) corresponds to an additional file of a file set containing the additional configuration. In such examples, the additional file of the file set corresponds to a different chunk of memory. The updating device continues to generate additional BRA call commands (BRA_CALL) until the host device provides the configuration data from all files of the file set. In such operations, the generation of additional BRA call commands (BRA_CALL) substantially increases the duration of the firmware update.

Some embodiments relate to methods and apparatus to update firmware using bulk register access (BRA) across non-consecutive memory addresses and, therefore, across different memory chunks. In some embodiments, a secondary device includes FDL circuitry and FDL decoder circuitry to decode context of a firmware update from configuration data. The FDL circuitry generates a BRA call command (BRA_CALL) responsive to a determination that a host device has a file including configuration data (also referred to as update data). In such examples, the configuration data includes a packet header, first data set, and second data set. The packet header provides context for the BRA data stream (BRA_DATA) or, more generally, the configuration data. For example, the packet header may include a payload length, which corresponds to the length of the configuration data. The first data set includes a first chunk header and chunk data. The example chunk header provides context of the chunk data. For example, the chunk header may include a chunk start address, which identifies a location in memory to write the chunk data. The chunk data represents the firmware update of the portion of memory corresponding to the chunk start address.

Similar to the first data set, the second data set includes a second chunk header and second chunk data. The second chunk header specifies a chunk start address to write the second chunk data. In example operations, the FDL decoder circuitry identifies the chunk headers from the BRA data stream. The FDL decoder circuitry writes the chunk data to the portions of memory specified by the chunk headers. In such example operations, the chunk headers allow the FDL decoder circuitry to write chunk data to different portions of memory without additional BRA call commands (BRA_CALL). Advantageously, in some embodiments, the FDL decoder circuitry decreases the duration of firmware updates by reducing the number of BRA call commands. Advantageously, in some embodiments, as further described herein, the FDL decoder circuitry allows the configuration data to support additional firmware update operations, such as Cyclic Redundancy Checks (CRCs), secondary interface writes, etc.

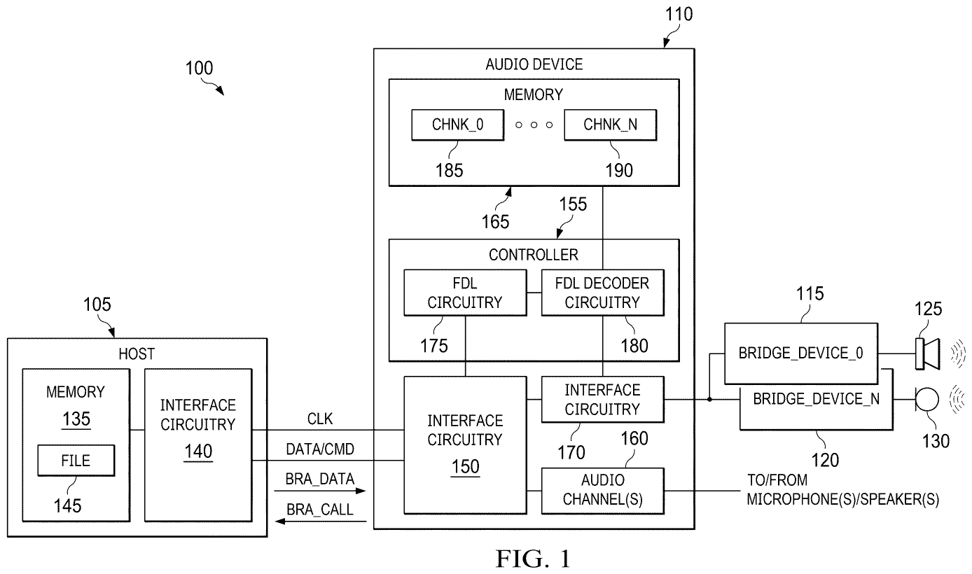

FIG. 1 is a block diagram of an example audio system 100. In the example of FIG. 1, the audio system 100 includes a host device 105, an audio device 110, a first bridge device 115, a second bridge device 120, a speaker 125, and a microphone 130. The example audio system 100 of FIG. 1 is an example of a SoundWire Device Class for Audio (SDCA) system, which implements SoundWire controls for audio functions. For example, the host device 105 and the audio device 110 communicate using SoundWire signaling protocols. Alternatively, the audio system 100 may implement an alternative set of controls, such as inter-integrated circuit (I2C), improved inter-integrated circuitry (I3C), serial peripheral interface (SPI), SLIMBus, Bluetooth, etc. In example operations, the audio system 100 produces soundwaves using the speaker 125 and receives soundwaves using the microphone 130.

The host device 105 (also referred to as a primary device) is communicatively coupled to the audio device 110. In some examples, the host device 105 and the audio device 110 are coupled by a bus including a clock signal (CLK) and a data signal (DATA). In such examples, the communication protocols allow the host device 105 and the audio device 110 to exchange commands using the data signal (DATA). For example, as part of a firmware update, the host device 105 receives a BRA call command (BRA_CALL) from the audio device 110. In such examples, the host device 105 provides BRA data stream (BRA_DATA) responsive to the BRA call command (BRA_CALL). The BRA call command (BRA_CALL) is a request from the audio device 110 for the host device 105 to provide a relatively large portion of data. The audio device 110 requests configuration data using the BRA call command (BRA_CALL). The host device 105 provides the relatively large portion of data as the BRA data stream (BRA_DATA). The example host device 105 of FIG. 1 includes example memory circuitry 135 and example interface circuitry 140.

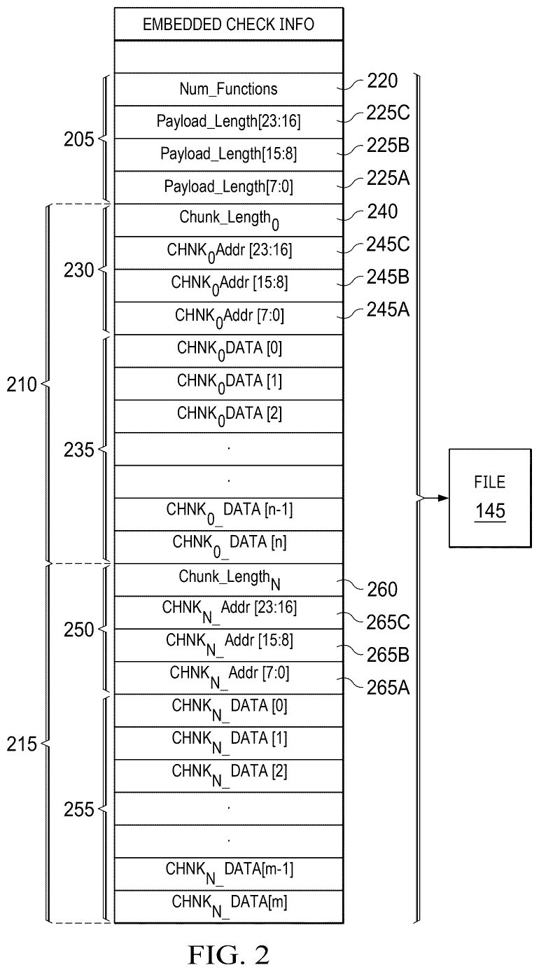

In example operations of the host device 105, the memory circuitry 135 stores example configuration data 145. The configuration data 145 is a compiled set of instructions representing at least a portion of a firmware image. In the example of FIG. 1, the configuration data 145 has update data corresponding to operations of the audio device 110 an update to an active firmware image. Examples of the configuration data 145 are further illustrated and described in connection with FIGS. 2, 7, and 9.

In such example operations of the host device 105, the interface circuitry 140 implements a communication protocol to interface with the audio device 110 using the clock signal (CLK) and the data signal (DATA). In some examples, the interface circuitry 140 implements the SoundWire protocol. Alternatively, the interface circuitry 140 may implement another communication protocol, such as I2C, I3C, SPI, etc.

The audio device 110 is communicatively coupled to the host device 105 by a first communication protocol. The audio device 110 is communicatively coupled to bridge devices 115, 120 by a second communication protocol. In some examples, the audio device 110 supports audio operations with the bridge devices 115, 120 despite having support for the first communication protocol. For example, the audio device 110 uses the SoundWire protocol to communicate with the host device 105 and the I2C protocol to communicate with the bridge devices 115, 120. In such examples, the audio device 110 does not need the bridge devices 115, 120 to support SoundWire protocols to exchange data with the host device 105. The example audio device 110 of FIG. 1 includes first example interface circuitry 150, an example controller 155, example audio channel(s) 160, example memory circuitry 165, and second example interface circuitry 170.

In example operations of the audio device 110, the interface circuitry 150 implements the first communication protocol to interface with the host device 105. In some examples, the interface circuitry 150 implements the SoundWire protocol, which uses the clock signal (CLK) and the data signal (DATA) to exchange data. Alternatively, the interface circuitry 150 may implement another communication protocol, such as I2C, I3C, SPI, etc. The interface circuitry 150 sequences use of the data signal (DATA) to provide data to the controller 155, the audio channel(s) 160, and the interface circuitry 170. The interface circuitry 150 sequences use of the data signal (DATA) to provide commands, such as the BRA call command (BRA_CALL), to the host device 105.

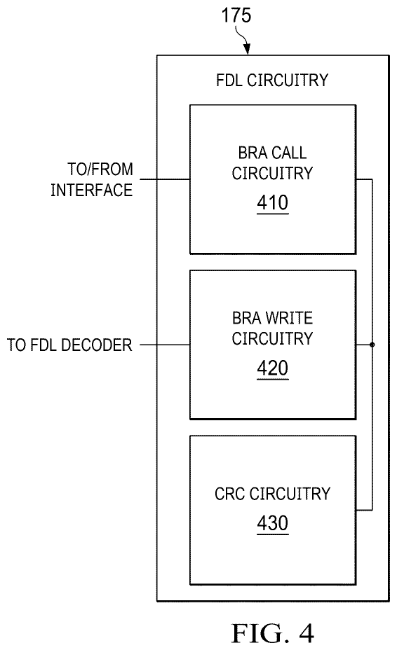

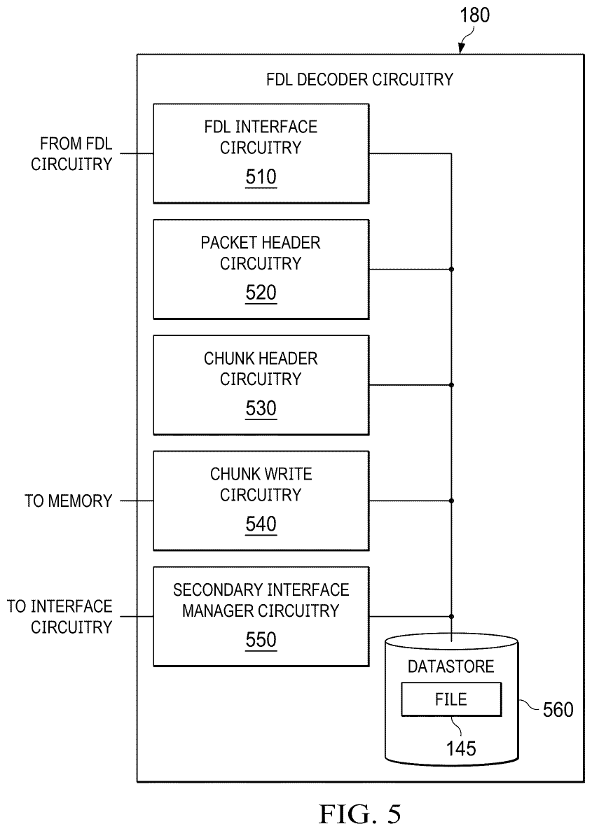

In such example operations of the audio device 110, the controller 155 performs operations to update firmware in the memory circuitry 165. For example, the controller 155 is configured to write data to the memory circuitry 165. The example controller 155 of FIG. 1 includes example FDL circuitry 175 and example FDL decoder circuitry 180. The FDL circuitry 175 generates the BRA call command (BRA_CALL) to initiate a firmware update. The FDL circuitry 175 provides the BRA data stream (BRA_DATA) from the interface circuitry 150 to the FDL decoder circuitry 180. In some examples, the BRA data stream (BRA_DATA) is a data stream representative of the configuration data 145, which represents an updated firmware image. The FDL decoder circuitry 180 decodes the configuration data 145 to determine context data of the firmware update. For example, the configuration data 145 includes a chunk header identifying a start memory address in the memory circuitry 165. In such examples, the FDL decoder circuitry 180 updates the firmware of the audio device 110 by writing a portion of the configuration data 145 to the memory circuitry 165. Examples of the FDL circuitry 175 and the FDL decoder circuitry 180 are further illustrated and described in connection with FIGS. 4 and 5.

In example operations of the audio device 110, the memory circuitry 165 stores a firmware image. In the example of FIG. 1, the memory circuitry 165 includes a first portion of memory 185 and a second portion of memory 190. However, in practice the memory circuitry 165 can include any number of portions of memory. In some examples, the portions of memory 185, 190 are referred to as a chunk of memory, a block of memory, memory portion, etc. The portions of memory 185, 190 form a firmware image. In some examples, the portions of memory 185, 190 store portions of the firmware image that correspond to different functions of the audio device 110. For example, the portion of memory 185 includes instructions to produce ultrasonic signals (signals having frequencies beyond the audible spectrum) for the speaker 125 and the portion of memory 190 includes instructions to determine distances using received ultrasonic signals from the microphone 130. During a firmware update, the FDL decoder circuitry 180 can write to any of the portions of memory 185, 190 to update the corresponding operations.

In example operations, the audio channel(s) 160 are analog components that allow the audio device 110 to be directly coupled to a speaker or microphone. For example, a first audio channel (CH1) of the audio channels 160 includes a digital-to-analog converter (DAC) to drive a speaker and a second audio channel (CH2) of the audio channels 160 includes an analog-to-digital converter (ADC) to receive audio from a microphone. In some examples, the audio channel(s) 160 exchange audio data with the host device 105 via the interface circuitry 150. Similarly, the bridge devices 115, 120 include circuitry to support audio generating and capturing audio signals.

In example operations, the interface circuitry 170 implements the second communication protocol to interface with the bridge devices 115, 120. In some examples, the interface circuitry 170 implements I2C. Alternatively, the interface circuitry 170 may implement another communication protocol, such as SoundWire, I3C, SPI, etc. The interface circuitry 170 sequences use of a data signal to exchange data with the bridge devices 115, 120.

FIG. 2 is a block diagram of an example of the configuration data 145 of FIG. 1 for a firmware update. In the example of FIG. 2, the configuration data 145 includes a packet header 205, a first data set 210, and a second data set 215. In example operations of the audio system 100, the host device 105 provides the configuration data 145 using the BRA data stream (BRA_DATA) responsive to a BRA call command (BRA_CALL) from the audio device 110. In such example operations, the FDL decoder circuitry 180 or, more generally, the controller 155 decodes the configuration data 145 to identify the packet header 205 and the data sets 210, 215.

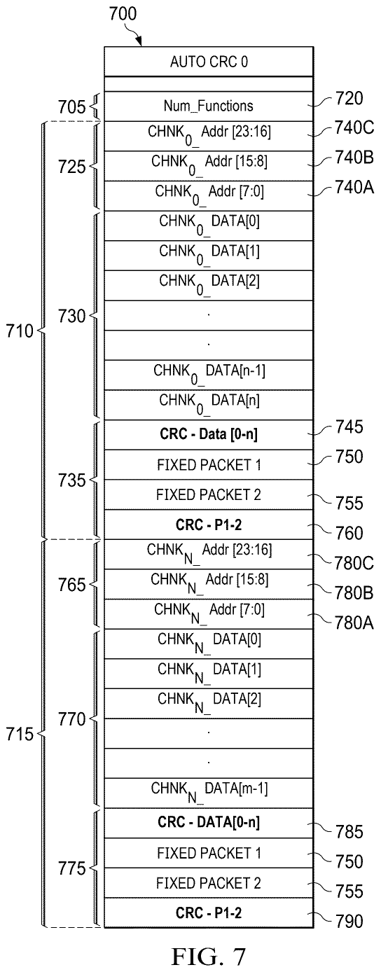

The packet header 205 is a first portion of the configuration data 145, which provides context to the update data of the configuration data 145. The example packet header 205 of FIG. 2 includes an example number of functions 220 and an example payload length 225. The number of functions 220 (Num_Functions) represents the number of operations that the FDL decoder circuitry 180 will perform during the firmware update of the configuration data 145. In some examples, the number of functions 220 represents the number of portions of memory being updated. For example, if the number of functions 220 is two, the configuration data 145 includes data sets for two chunks of memory, such as the portions of memory 185, 190. In other examples, the number of functions 220 represents the number of operations the controller 155 will perform during the firmware update of the configuration data 145. For example, if the configuration data 145 includes Cyclic Redundancy Check (CRC) data, such as in FIG. 7, the number of functions 220 is increased to include CRCs.

The payload length 225 (Payload_Length) is a payload length field that represents the length of the BRA data stream (BRA_DATA) or, more generally, the configuration data 145. In some examples, such as in FIG. 2, the payload length 225 is a value that exceeds the maximum value of a single word (e.g., eight bits, sixteen bits, etc.). In such examples, a plurality of words represent the payload length 225. For example, words 225A, 225B, 225C each store a portion of the payload length 225 (Payload_Length[23:0]). Alternatively, the payload length 225 (Payload_Length) may include any number of words.

The data set 210 is a second portion of the configuration data 145, which provides update data for a portion of memory, such as one of the portions of memory 185, 190. The example data set 210 of FIG. 2 includes an example chunk header 230 and example chunk data 235. The chunk header 230 provides context to the chunk data 235. The example chunk header 230 of FIG. 2 includes an example chunk data length 240 and an example chunk start address 245. The chunk data length 240 (Chunk_Length₀) represents the length of the chunk data 235. In some examples, the chunk length 240 corresponds to a number of words that form the chunk data 235. In other examples, the chunk length 240 corresponds to a number of bits that form the chunk data. In both examples, the chunk length 240 does not need to correspond to a total length of a corresponding portion of memory. For example, the chunk length 240 may indicate the chunk data 235 is smaller than the total length of the portion of memory 185.

The chunk start address 245 (CHNK₀_Addr[23:0]) represents a memory address in the memory circuitry 165. In example operation, the chunk start address 245 identifies a location in the memory address to begin writing the chunk data 235. In some examples, the chunk start address 245 identifies a memory address that is not the start memory address of a portion of memory. Instead, the chunk start address 245 can correspond to a memory location within the portion of memory. For example, if the chunk data 235 is only updating a portion of the portion of memory 185, the chunk start address 245 can be between the start and end addresses of the portion of memory 185. Similar to the payload length 225, in some examples, a plurality of words represents the chunk start address 245. For example, words 245A, 245B, 245C each store a portion of the chunk start address 245 (CHNK₀_Addr[23:0]). The chunk start address 245 may include any number of words.

The data set 215 is a third portion of the configuration data 145, which provides update data for another portion of memory, such as one of the portions of memory 185, 190. The example data set 215 of FIG. 2 includes an example chunk header 250 and example chunk data 255. The chunk header 250 provides context to the chunk data 255. The example chunk header 250 of FIG. 2 includes an example chunk data length 260 and an example chunk start address 265. The chunk length 260 (Chunk_Length_{N}) represents the length of the chunk data 255. In some examples, the chunk length 260 corresponds to a number of words that form the chunk data 255. In other examples, the chunk length 260 corresponds to a number of bits that form the chunk data. In both examples, the chunk length 260 does not need to correspond to a total length of a corresponding portion of memory. For example, the chunk length 260 may indicate the chunk data 255 is smaller than the total length of the portion of memory 190.

The chunk start address 265 (CHNK_{N}_Addr[23:0]) represents a memory address in the memory circuitry 165. In example operations, the chunk start address 265 identifies a location in the memory address to begin writing the chunk data 255. In some examples, the chunk start address 265 identifies a memory address that is not the start memory address of a portion of memory. Instead, the chunk start address 265 can correspond to a memory location within the portion of memory. For example, if the chunk data 255 is only updating a portion of the portion of memory 190, the chunk start address 265 can be between the start and end addresses of the portion of memory 190. Similar to the payload length 225, in some examples, the chunk start address 265 is represented by a plurality of words. For example, words 265A, 265B, 265C each store a portion of the chunk start address 265 (CHNK_{N}_Addr[23:0]). The chunk start address 265 may include any number of words.

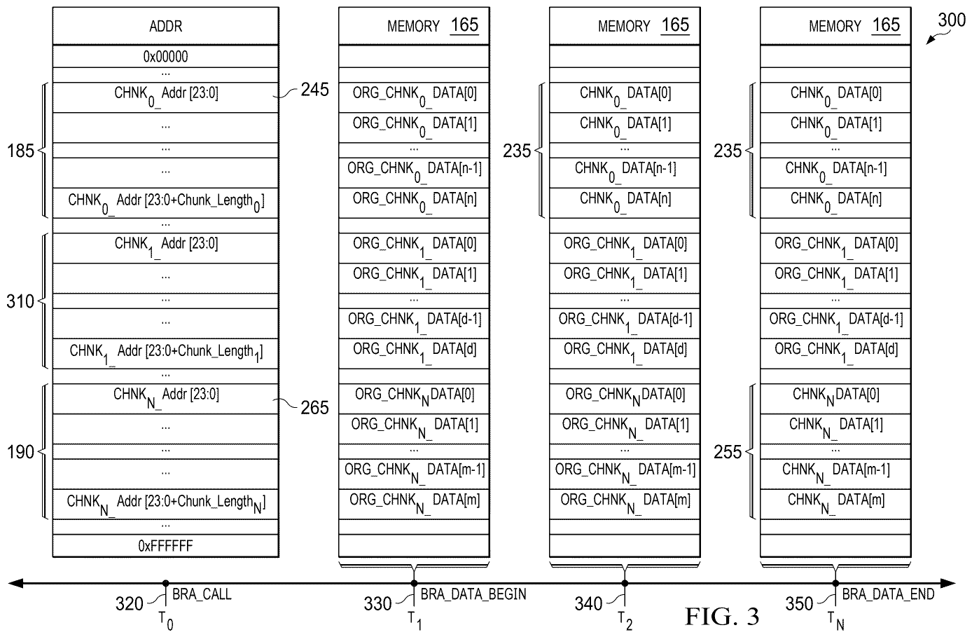

FIG. 3 is a timing diagram 300 of example operations of the FDL decoder circuitry 180 to update firmware in the memory circuitry 165. In the example of FIG. 3, the memory circuitry 165 includes the portions of memory 185, 190 and a third portion of memory 310. The example portion of memory 310 (CHNK₁) of FIG. 3 spans a range of memory addresses between an end address of the portion of memory 185 (CHNK₀) and a start address of the portion of memory 190 (CHNK_{N}). In some examples, the portion of memory 185 includes memory addresses being consecutive addresses to the memory addresses of the portion of memory 185. The timing diagram 300 illustrates the operations of the FDL decoder circuitry 180 when the data set 210 corresponds to the portion of memory 185 (CHNK₀) and the data set corresponds to the portion of memory 190 (CHNK_{N}). Advantageously, the chunk headers 230, 250 allow the FDL decoder circuitry 180 to update non-consecutive portions of the memory circuitry 165 without additional BRA call commands.

At a first time 320 (T₀), the FDL circuitry 175 generates a BRA call command (BRA_CALL) to initialize a firmware update. At a second time 330 (T₁), the host device 105 starts providing the BRA data stream (BRA_DATA) responsive to the BRA call command (BRA_CALL). The BRA data stream (BRA_DATA) corresponds to the configuration data 145. At the time 330, the portion of memory 185 contains first original chunk data (ORG_CHNK₀_DATA[n:0]), the portion of memory 310 contains second original chunk data (ORG_CHNK₁_DATA[d:0]), and the portion of memory 190 contains third original chunk data (ORG_CHNK_{N}_DATA[m:0]).

Between the second time 330 and a third time 340 (T₂), the FDL decoder circuitry 180 writes the chunk data 235 (CHNK₀_DATA[n:0]) to the portion of memory 185. In such example operations, the FDL decoder circuitry 180 uses the start address 245 to identify an address in the portion of memory 185 to start writing the chunk data 235. In the example of FIG. 3, the start address 245 corresponds to a start address of the portion of memory 185. However, in other examples, the start address 245 corresponds to any address inside the range of memory addresses corresponding to the portion of memory 185. After the third time 340 (T₂), the portion of memory 185 contains the chunk data 235 (CHNK₀_DATA[n:0]), the portion of memory 310 contains the original chunk data (ORG_CHNK₁_DATA[d:0]), and the portion of memory 190 contains the original chunk data (ORG_CHNK_{N}_DATA[m:0]).

Between the third time 340 and a fourth time 350 (T_{N}), the FDL decoder circuitry 180 writes the chunk data 255 (CHNK_{N}_DATA[m:0]) to the portion of memory 190. In such example operations, the FDL decoder circuitry 180 uses the start address 265 to identify an address in the portion of memory 190 to start writing the chunk data 255. In the example of FIG. 3, the start address 265 corresponds to a start address of the portion of memory 190. Alternatively, in some other examples, the start address 265 corresponds to an address inside the range of memory addresses corresponding to the portion of memory 190. After the fourth time 350 (T_{N}), the portion of memory 185 contains the chunk data 235 (CHNK₀_DATA[n:0]), the portion of memory 310 contains the original chunk data (ORG_CHNK₁_DATA[d:0]), and the portion of memory 190 contains chunk data 255 (CHNK_{N}_DATA[m:0]).

Advantageously, between the times 340, 350, the chunk headers 230, 250 allow the FDL decoder circuitry 180 to update discontinuous portions of the memory circuitry 165 without additional BRA call commands. Advantageously, reducing the number of BRA call commands reduces duration of the firmware update.

FIG. 4 is a block diagram of an example implementation of the FDL circuitry 175 of FIG. 1. The FDL circuitry of FIG. 4 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Also or alternatively, the FDL circuitry 175 of FIG. 4 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 4 may, thus, be instantiated at the same or different times. Some or all of the circuitry of FIG. 4 may be instantiated, for example, in one or more threads executing concurrently on hardware or in series on hardware. Moreover, in some examples, some or all of the circuitry of FIG. 4 may be implemented by microprocessor circuitry executing instructions or FPGA circuitry performing operations to implement one or more virtual machines or containers. In the example of FIG. 4, the FDL circuitry 175 includes example BRA call circuitry 410, example BRA write circuitry 420, and example CRC circuitry 430.

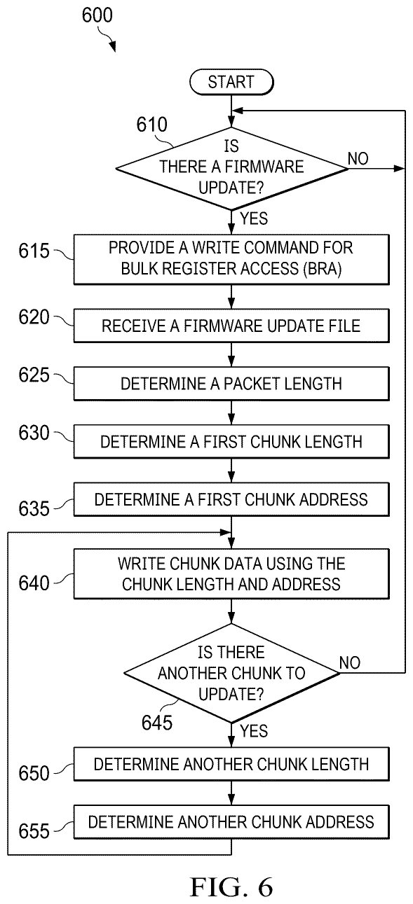

The BRA call circuitry 410 generates a BRA call command (BRA_CALL). In example operations, the BRA call circuitry 410 provides the BRA call command (BRA_CALL) to the interface circuitry 150 to start a firmware update. In some examples, the BRA call circuitry 410 determines a firmware update is to occur responsive to a file download (FDL) status indication. In such examples, the host device 105 may provide the FDL indication in response to receiving the configuration data 145. The BRA call circuitry 410 may use the FDL indication to determine the portions of the memory circuitry 165 that correspond to the update. In some examples, the BRA call circuitry 410 is instantiated by ASIC or programmable circuitry executing BRA call instructions to perform operations such as those represented by the flowcharts of FIGS. 6, 8, and 11.

The BRA write circuitry 420 provides the BRA data stream (BRA_DATA) to the FDL decoder circuitry 180. In some examples, the BRA write circuitry 420 buffers the BRA data stream (BRA_DATA) from the interface circuitry 150. In other examples, the BRA write circuitry 420 provides the FDL decoder circuitry 180 access to the BRA data stream (BRA_DATA) responsive to writing the BRA data stream (BRA_DATA) to a temporary memory location. In some examples, the BRA write circuitry 420 is instantiated by ASIC or programmable circuitry executing BRA write instructions to perform operations such as those represented by the flowcharts of FIGS. 6, 8, and 11.

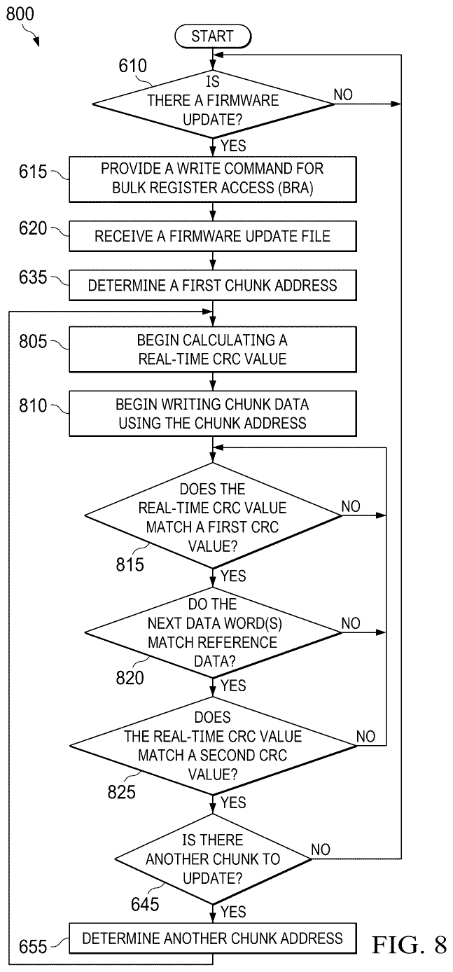

The CRC circuitry 430 calculates a real-time CRC value as the FDL decoder circuitry 180 writes to the memory circuitry 165. In some examples, the CRC circuitry 430 compares the calculated CRC value to a CRC value from the BRA data stream (BRA_DATA). In such examples, the CRC circuitry 430 verifies the write to the memory circuitry 165 was successful responsive to the calculated CRC value matching the received CRC value. In some examples, the CRC circuitry 430 is instantiated by ASIC or programmable circuitry executing CRC instructions to perform operations such as those represented by the flowchart of FIG. 8.

FIG. 5 is a block diagram of an example implementation of the FDL decoder circuitry 180 of FIG. 1. The FDL decoder circuitry 180 of FIG. 5 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Also or alternatively, the FDL decoder circuitry 180 of FIG. 5 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 5 may, thus, be instantiated at the same or different times. Some or all of the circuitry of FIG. 5 may be instantiated, for example, in one or more threads executing concurrently on hardware or in series on hardware. Moreover, in some examples, some or all of the circuitry of FIG. 5 may be implemented by microprocessor circuitry executing instructions or FPGA circuitry performing operations to implement one or more virtual machines or containers. In the example of FIG. 5, the FDL decoder circuitry 180 includes example FDL interface circuitry 510, example packet header circuitry 520, example chunk header circuitry 530, example chunk write circuitry 540, example interface manager circuitry 550, and an example datastore 560.

The FDL interface circuitry 510 receives the BRA data stream (BRA_DATA) from the FDL circuitry 175. In some examples, the FDL interface circuitry 510 stores portions of the BRA data stream (BRA_DATA) in the datastore 560. In such examples, the FDL interface circuitry 510 forms portions of the configuration data 145 in the datastore 560. In some examples, the FDL interface circuitry 510 is instantiated by ASIC or programmable circuitry executing FDL interface instructions to perform operations such as those represented by the flowcharts of FIGS. 6, 8, and 11.

The packet header circuitry 520 identifies the packet header 205 of the configuration data 145. The packet header circuitry 520 determines the context of the configuration data 145 using the packet header 205. In some examples, such as in the configuration data 145 of FIG. 2, the packet header circuitry 520 determines the number of functions 220 and the payload length 225. In example operations, the packet header circuitry 520 uses data of the packet header 205 to track the BRA data stream (BRA_DATA) and the operations of the chunk write circuitry 540. For example, the packet header circuitry 520 can use the number of functions 220 and the payload length 225 to confirm a successful firmware update. In other examples, the packet header circuitry 520 may provide data from the packet header 205 to another component of the FDL decoder circuitry 180. In some examples, the packet header circuitry 520 is instantiated by ASIC or programmable circuitry executing packet header instructions to perform operations such as those represented by the flowcharts of FIGS. 6, 8, and 11.

The chunk header circuitry 530 identifies the chunk headers 230, 250 of the configuration data 145. The chunk header circuitry 530 determines context of subsequent chunk data, such as the chunk data 235, 255, using the corresponding chunk header. For example, the chunk header circuitry 530 determines the chunk length 260 and the chunk start address 265 from the chunk header 250. In example operations, the chunk header circuitry 530 provides the chunk length 260 and the chunk start address 265 to the chunk write circuitry 540. In some examples, the chunk header circuitry 530 is instantiated by ASIC or programmable circuitry executing chunk header instructions to perform operations such as those represented by the flowcharts of FIGS. 6, 8, and 11.

The chunk write circuitry 540 identifies the chunk data 235, 255 of the configuration data 145. The chunk write circuitry 540 receives the chunk lengths 240, 260 and the chunk start addresses 245, 265 from the chunk header circuitry 530. In example operations, the chunk write circuitry 540 writes the chunk data 235, 255 using the chunk lengths 240, 260 and the chunk start addresses 245, 265. In some examples, the chunk write circuitry 540 is instantiated by ASIC or programmable circuitry executing chunk write instructions to perform operations such as those represented by the flowcharts of FIGS. 6, 8, and 11.

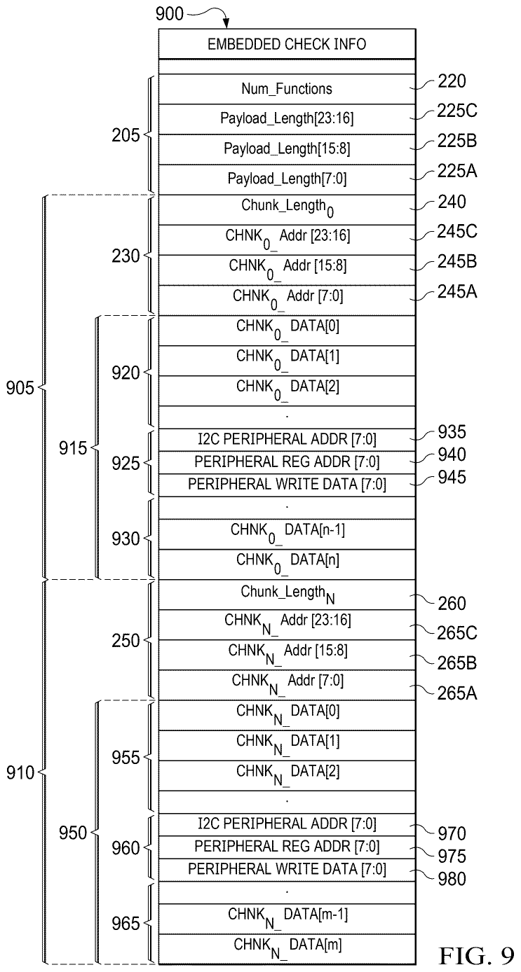

The interface manager circuitry 550 identifies peripheral data in the BRA data stream (BRA_DATA). In some examples, the interface manager circuitry 550 checks for peripheral data after a fixed number of words of the BRA data stream (BRA_DATA). The interface manager circuitry 550 provides the peripheral data to the interface circuitry 170. In some examples, such as in FIG. 9, the interface manager circuitry 550 allows the configuration data 145 to contain commands for the bridge devices 115, 120. In such examples, the interface circuitry 170 may provide commands to the bridge devices 115, 120 during the firmware update. In some examples, the interface manager circuitry 550 is instantiated by ASIC or programmable circuitry executing interface manager instructions to perform operations such as those represented by the flowcharts of FIGS. 6, 8, and 11.

FIG. 6 is a flowchart of embodiment method 600, according to an embodiment of the present disclosure. Method 600 may be executed, instantiated, or performed using an example implementation of the FDL circuitry 175 of FIGS. 1 and 4 and the FDL decoder circuitry 180 of FIGS. 1 and 5 to update the firmware of the audio system 100 of FIG. 1 using the configuration data 145 of FIG. 2.

Method 600 begin at Block 610 at which the BRA call circuitry 410 determines if there is a firmware update. In example operations, the BRA call circuitry 410 reads an FDL status of the host device 105. In some examples, the BRA call circuitry 410 compares the FDL status of the host device 105 to an FDL index of a current firmware of the audio device 110. In such examples, the BRA call circuitry 410 determines that the host device 105 has the configuration data 145 for updating the firmware of the audio device 110 responsive to the comparison. In other examples, the BRA call circuitry 410 may receive an indication or periodically check if a firmware update is available in the host device 105. If the BRA call circuitry 410 determines that there is no firmware update (e.g., Block 610 returns a result of NO), control proceeds to return to Block 610.

If the BRA call circuitry 410 determines that there is a firmware update (e.g., Block 610 returns a result of YES), the BRA call circuitry 410 provides a write command for bulk register access (BRA). (Block 615). In example operations, the BRA call circuitry 410 waits for the audio device 110 to be ready for a firmware update. In some examples, the BRA call circuitry 410 determines the audio device 110 is ready for a firmware update responsive to discontinuing audio operations. In such examples, the BRA call circuitry 410 may wait for a break in audio operations or generate an interrupt (e.g., alert, alarm, etc.) to halt operations of the audio device 110. In such example operations, the BRA call circuitry 410 provides a BRA call command (BRA_CALL) to the host device 105 to initialize the transfer of the configuration data 145. The BRA call circuitry 410 provides the BRA call command (BRA_CALL) to request the configuration data 145 from the host device 105. Alternatively, the BRA call circuitry 410 may use an alternative procedure for initiating a transfer of the configuration data 145 from the host device 105.

The FDL interface circuitry 510 receives a firmware update file. (Block 620). In example operations, the host device 105 drives the BRA data stream (BRA_DATA) responsive to the BRA call command. In such example operations, the BRA data stream (BRA_DATA) is a data stream representation of the configuration data 145. In some examples, the FDL interface circuitry 510 buffers the BRA data stream (BRA_DATA) to construct portions of the configuration data 145. For example, the FDL interface circuitry 510 constructs the packet header 205 responsive to buffering the first four words of the BRA data stream (BRA_DATA) in the datastore 560. In other examples, the FDL interface circuitry 510 buffers the BRA data stream (BRA_DATA) by providing portions of the BRA data stream (BRA_DATA) to different locations. For example, the FDL interface circuitry 510 provides the portions of the BRA data stream (BRA_DATA) corresponding to the packet header 205 to the packet header circuitry 520. Advantageously, the FDL interface circuitry 510 makes portions of the configuration data 145 accessible to different components of the FDL decoder circuitry 180.

The packet header circuitry 520 determines a packet length. (Block 625). In example operations, the packet header circuitry 520 identifies the packet header 205. In such examples, the packet header circuitry 520 determines the payload length 225 from the packet header 205. In some examples, the packet header circuitry 520 determines the payload length 225 by combining multiple sequential words of the BRA data stream (BRA_DATA). For example, the packet header circuitry 520 determines a twenty-four bit representation of the payload length 225 (Payload_Length[23:0]) by combining the words 225A, 225B, 225C. Advantageously, the packet header circuitry 520 makes the payload length 225 accessible to the FDL decoder circuitry 180. Advantageously, the FDL decoder circuitry 180 may use the payload length 225 to determine the end of the BRA data stream (BRA_DATA).

The chunk header circuitry 530 determines a first chunk length. (Block 630). In example operations, the chunk header circuitry 530 identifies the chunk header 230. In such examples, the chunk header circuitry 530 determines the chunk length 240 (CHNK_Length₀) from the chunk header 230. For example, the chunk header circuitry 530 determines the chunk length 240 corresponds to the first word of the data set 210. In such example operations, the chunk length 240 represents the length of the chunk data 235. Advantageously, the chunk header circuitry 530 makes the chunk length 240 accessible to the FDL decoder circuitry 180. Advantageously, the FDL decoder circuitry 180 may use the chunk length 240 to determine the length of the chunk data 235.

The chunk header circuitry 530 determines a first chunk address. (Block 635). In example operations, the chunk header circuitry 530 identifies the chunk header 230. In such examples, the chunk header circuitry 530 determines the chunk start address 245 from the chunk header 230. For example, the chunk header circuitry 530 determines the chunk start address 245 corresponds to the words 245A, 245B, 245C of the data set 210. In such example operations, the chunk start address 245 represents an address in the memory circuitry 165 to begin writing the chunk data 235. Advantageously, the chunk header circuitry 530 makes the chunk start address 245 accessible to the FDL decoder circuitry 180. Advantageously, the FDL decoder circuitry 180 may use the chunk start address 245 to identify a location in the memory circuitry 165 to write the chunk data 235.

The chunk write circuitry 540 writes chunk data using the chunk length and address. (Block 640). In example operations, the chunk write circuitry 540 begins to write the chunk data 235 to the chunk start address 245 in the memory circuitry 165. In such example operations, the chunk write circuitry 540 continues writing the chunk data 235 to consecutive addresses of the memory circuitry 165. In some examples, the chunk write circuitry 540 completes the write the chunk data 235 after writing data from the chunk start address 245 plus the chunk length 240. In such examples, the consecutive addresses of the memory circuitry 165 correspond to the update of a portion of memory using the data set 210.

The packet header circuitry 520 determines if there is another chunk to update. (Block 645). In example operations, the packet header circuitry 520 uses at least one of the number of functions 220 or the payload length 225 to determine if the configuration data 145 includes another data set. For example, after the chunk write circuitry 540 writes the chunk data 235, the packet header circuitry 520 compares the number of performed functions or the current length of the BRA data stream (BRA_DATA) to the number of functions 220 or the payload length 225. In such examples, the packet header circuitry 520 determines if there is another portion of memory to update responsive to the comparison. If the packet header circuitry 520 determines there is not another chunk to update (e.g., Block 645 returns a result of NO), control proceeds to return to Block 610.

If the packet header circuitry 520 determines there is another chunk to update (e.g., Block 645 returns a result of YES), the chunk header circuitry 530 determines another chunk length. (Block 650). In example operations, the chunk header circuitry 530 identifies the chunk header 250. In such examples, the chunk header circuitry 530 determines the chunk length 260 (CHNK_Length_{N}) from the chunk header 250. For example, the chunk header circuitry 530 determines the chunk length 260 corresponds to the first word of the data set 215. In such example operations, the chunk length 260 represents the length of the chunk data 255. Advantageously, the chunk header circuitry 530 makes the chunk length 260 accessible to the FDL decoder circuitry 180. Advantageously, the FDL decoder circuitry 180 may use the chunk length 260 to determine the length of the chunk data 255.

The chunk header circuitry 530 determines another chunk address. (Block 655). In example operations, the chunk header circuitry 530 identifies the chunk header 250. In such examples, the chunk header circuitry 530 determines the chunk start address 265 from the chunk header 250. For example, the chunk header circuitry 530 determines the chunk start address 265 corresponds to the words 265A, 265B, 265C of the data set 215. In such example operations, the chunk start address 265 represents an address in the memory circuitry 165 to begin writing the chunk data 255. Advantageously, the chunk header circuitry 530 makes the chunk start address 265 accessible to the FDL decoder circuitry 180. Advantageously, the FDL decoder circuitry 180 may use the chunk start address 265 to identify a location in the memory circuitry 165 to write the chunk data 255. Control proceeds to return to Block 640. However, unlike in the example described above, the chunk write circuitry 540 writes the chunk data 255.

Example methods are described with reference to the flowchart illustrated in FIG. 6. However, many other methods of implementing the FDL circuitry 175 of FIGS. 1 and 4 and the FDL decoder circuitry 180 of FIGS. 1 and 5 or, more generally, the audio system 100 of FIG. 1 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

FIG. 7 is a block diagram of example configuration data 700, according to an embodiment of the present disclosure. Configuration data 700 is another example of the configuration data 145 of FIGS. 1 and 2. In the example of FIG. 7, the configuration data 700 includes a packet header 705, a first data set 710, and a second data set 715. In example operations of the audio system 100, the host device 105 provides the configuration data 700 using the BRA data stream (BRA_DATA). In such example operations, the FDL decoder circuitry 180 or, more generally, the controller 155 decodes the configuration data 700 to identify the packet header 705 and the data sets 710, 715.

The packet header 705 is a portion of the configuration data 145 that provides context to the configuration data 700. The example packet header 705 of FIG. 7 includes an example number of functions 720. The number of functions 720 (Num_Functions) represents the number of operations that the FDL decoder circuitry 180 will perform during the firmware update of the configuration data 700. The number of functions 720 is another example of the number of functions 220. Advantageously, the CRCs described herein allow the packet header 705 to not include a payload length, such as the payload length 225.

The data set 710 is a second portion of the configuration data 700. The data set 710 provides update data for a portion of memory, such as the portions of memory 185, 190, 310. The example data set 710 of FIG. 7 includes an example chunk header 725, example chunk data 730, and example CRC data 735. The chunk header 725 provides context to the chunk data 730. The example chunk header 725 of FIG. 7 includes an example chunk start address 740. The chunk start address 740 (CHNK₀_Addr[23:0]) represents a memory address in the memory circuitry 165. The chunk start address 740 is another example of the chunk start addresses 245, 265. Advantageously, the CRCs described herein allow the chunk header 725 to not include a chunk length, such as the chunk lengths 240, 260.

The CRC data 735 provides context to the CRCs of the transmission and writing of the chunk data 730. The example CRC data 735 of FIG. 7 includes a first example CRC value 745, first example default data 750, second example default data 755, and a second example CRC value 760. The CRC values 745, 760 represent check values for the chunk data 730. In some examples, a function produces the CRC value 745 as a product of the chunk data 730. In example operations, as further described in connection with FIG. 8, the FDL circuitry 175 verifies the BRA data stream (BRA_DATA) accurately provides the chunk data 730 by comparing a real-time CRC value to the CRC value 745. In such examples, the FDL circuitry 175 detects the end of the chunk data 730 responsive to the real-time CRC value matching the CRC value 745.

The default data 750, 755 (also referred to as fixed data packet(s)) provides additional context for the CRCs of the CRC values 745, 760. The default data 750, 755 is fixed values that allow the FDL circuitry 175 to verify the end of the chunk data 730. In example operations, if the FDL circuitry 175 may calculate a real-time CRC value that matches the CRC value 745, but the BRA data stream (BRA_DATA) has only provided a portion of the chunk data 730. In such example operations, the FDL circuitry 175 identifies the accidental match by comparing the subsequent data words to the expected values of the default data 750, 755. Advantageously, the default data 750, 755 provides reference values to verify the accuracy of the CRC.

The data set 715 is a third portion of the configuration data 700. The data set 715 provides update data for a portion of memory, such as the portions of memory 185, 190, 310. The example data set 715 of FIG. 7 includes an example chunk header 765, example chunk data 770, and example CRC data 775. The chunk header 765 provides context to the chunk data 770. The example chunk header 765 of FIG. 7 includes an example chuck start address 780. The chunk start address 780 (CHNK_{N}_Addr[23:0]) represents a memory address in the memory circuitry 165. The chunk start address 780 is another example of the chunk start addresses 245, 265, 740. Advantageously, the CRCs described herein allow the chunk header 765 to not include a chunk length, such as the chunk lengths 240, 260.

The CRC data 775 provides context to the CRCs of the transmission and writing of the chunk data 770. The example CRC data 775 of FIG. 7 includes the default data 750, 755, a first example CRC value 785, and a second example CRC value 790. The CRC values 785, 790 represent check values for the chunk data 770. In some examples, a function produces the CRC value 785 as a product of the chunk data 770. In example operations, as further described in connection with FIG. 8, the FDL circuitry 175 verifies the BRA data stream (BRA_DATA) accurately provides the chunk data 770 by comparing a real-time CRC value to the CRC values 785, 790. In such examples, the FDL circuitry 175 detects the end of the chunk data 730 responsive to the real-time CRC value matching the CRC value 785. Advantageously, the FDL circuitry 175 uses the default data 750, 755 to reduce a likelihood of accidentally matching CRC values.

FIG. 8 is a flowchart of embodiment method 800, according to an embodiment of the present disclosure. Method 800 may be executed, instantiated, or performed using an example implementation of the FDL circuitry 175 of FIGS. 1 and 4 and the FDL decoder circuitry 180 of FIGS. 1 and 5 to update the firmware of the audio system 100 of FIG. 1 using the configuration data 700 of FIG. 7.

Method 800 begin with the example operations of Blocks 610, 615, 620, 635 of FIG. 6. In such example operations, the FDL circuitry 175 and the FDL decoder circuitry 180 generate a BRA call command (BRA_CALL) and begin receiving the configuration data 700 as the BRA data stream (BRA_DATA). Control proceeds to Block 805.

The CRC circuitry 430 begins calculating a real-time CRC value. (Block 805). In example operations, the CRC circuitry 430 implements a function to calculate a real-time CRC value as the BRA data stream (BRA_DATA) provides portions of the configuration data 700. In some examples, the CRC circuitry 430 determines the real-time CRC value for portions of the configuration data 700. In other examples, the CRC circuitry 430 determines a global real-time CRC value by using the CRC function since the beginning of the BRA data stream (BRA_DATA).

The chunk write circuitry 540 begins writing chunk data using the start address. (Block 810). In example operations, the chunk write circuitry 540 begins to write the chunk data 730 to the chunk start address 740. In such example operations, the chunk write circuitry 540 continues writing the chunk data 730 to consecutive memory addresses.

The CRC circuitry 430 determines if the CRC of the data write to the chunk matches a first CRC value. (Block 815). In example operations, the CRC circuitry 430 uses the CRC function to update the real-time CRC value as the BRA data stream (BRA_DATA) continues. In such example operations, the CRC circuitry 430 compares the real-time CRC value to a subsequent packet(s) of the BRA data stream (BRA_DATA). In some examples, the CRC circuitry 430 detects the end of the chunk data 730 responsive to the subsequent packet(s) being equal to the real-time CRC value. In such examples, the CRC circuitry 430 identifies the subsequent packet(s) as the CRC value 745. In other examples, the CRC circuitry 430 determines the CRC value 745 from the datastore 560. If the CRC circuitry 430 determines the CRC of the data write to the chunk does not match the first CRC value (e.g., Block 815 returns a result of NO), control proceeds to return to Block 815.

If the CRC circuitry 430 determines the CRC of the data write to the chunk does match the first CRC value (e.g., Block 815 returns a result of YES), the CRC circuitry 430 determines if the next data words match fixed CRC data. (Block 820). In example operations, after the real-time CRC value matches the subsequent packet(s), the CRC circuitry 430 uses the default data 750, 755 to confirm the subsequent packet(s) are the CRC value 745. In some examples, the CRC circuitry 430 compares subsequent packets of the BRA data stream (BRA_DATA) to expected reference values (also referred to as reference data packet(s)). If the subsequent packet(s) match the reference values, the CRC circuitry 430 identifies the packets as the default data 750, 755. Advantageously, the default data 750, 755 allows the CRC circuitry 430 to verify the real-time CRC value matches the CRC value 745. If the CRC circuitry 430 determines the next data words do not match the fixed CRC data (e.g., Block 820 returns a result of NO), control proceeds to return to Block 815.

If the CRC circuitry 430 determines the next data words match the fixed CRC data (e.g., Block 820 returns a result of YES), the CRC circuitry 430 determines if the current CRC value matches a second CRC value. (Block 825). In example operations, after confirming the real-time CRC value matches the CRC value 745 using the default data 750, 755, the CRC circuitry 430 verifies the reception of the chunk data 730 by comparing the real-time CRC value to the CRC value 760. In such example operations, the CRC circuitry 430 uses the additional CRC of the CRC value 760 to confirm transmission of the data set 710. In some examples, the CRC circuitry 430 may use the CRC values 745, 760 to verify a successful write of the chunk data 730 to the memory circuitry 165. If the CRC circuitry 430 determines the current CRC value does not match the second CRC value (e.g., Block 825 returns a result of NO), control proceeds to return to Block 815. If the CRC circuitry 430 determines the current CRC value does match the second CRC value (e.g., Block 825 returns a result of YES), control proceeds with the operations of Blocks 645, 655.

Example methods are described with reference to the flowchart illustrated in FIG. 8. However, many other methods of implementing the FDL circuitry 175 of FIGS. 1 and 4 and the FDL decoder circuitry 180 of FIGS. 1 and 5 to update the audio system 100 of FIG. 1 using the configuration data 700 of FIG. 7 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

FIG. 9 is a block diagram of example configuration data 900, according to an embodiment of the present disclosure. Configuration data 900 is yet another example of the configuration data 145, 700 of FIGS. 1, 2, and 7. In the example of FIG. 9, the configuration data 900 includes the packet header 205, a first data set 905, and a second data set 910. In example operations of the audio system 100, the host device 105 provides the configuration data 900 using the BRA data stream (BRA_DATA). In such example operations, the FDL decoder circuitry 180 or, more generally, the controller 155 decodes the configuration data 900 to identify the packet header 205 and the data sets 905, 910. As further described in connection with FIG. 2, the packet header 205 is a first portion of the configuration data 900, which provides context for the update data of the configuration data 900.

The data set 905 is a second portion of the configuration data 900, which provides update data for a portion of memory, such as one of the portions of memory 185, 190. The data set 905 is another example of the data sets 210, 215, 710, 715. The example data set 905 of FIG. 9 includes the chunk header 230 and example chunk data 915.

The chunk data 915 is another example of the chunk data 235, 255, 730, 770. Unlike the chunk data 235, 255, 730, 770, the example chunk data 915 of FIG. 9 includes a first example portion of chunk data 920, example peripheral data 925, and a second example portion of chunk data 930. The portions of chunk data 920, 930 contain update data of a portion of memory specified in the chunk header 230. In some examples, such as in FIG. 9, the peripheral data 925 divides the chunk data 915 into the portions of chunk data 920, 930. In such examples, the chunk data 915 may include any number of instances of the peripheral data 925 dividing the chunk data 915 into any number of portions. Also, in some examples, the configuration data 900 may be structured to include an instance of the peripheral data 925 in regular intervales. For example, the configuration data 900 includes an instance of the peripheral data 925 after every two-hundred words of the chunk data 915. In such examples, the instances of the peripheral data 925 set the maximum length of each of the portions of chunk data 920, 930 to two-hundred words.

The peripheral data 925 represents peripheral device commands for devices coupled to the secondary device being updated. For example, the peripheral data 925 corresponds to commands from the interface circuitry 170 to one or more of the bridge devices 115, 120. In some such examples, the peripheral data 925 is set to produce commands using communication protocol of the interface circuitry 170, such as I2C, SPI, I3C, etc. The example peripheral data 925 of FIG. 9 includes an example peripheral device address 935, an example peripheral register address 940, and example peripheral write data 945. The peripheral device address 935 represents the one or more of the bridge devices 115, 120 receiving the peripheral command. The peripheral register address 940 corresponds to a register of the one or more bridge devices 115, 120 of the peripheral device address 935. The peripheral write data 945 is data to store in the register of the register address 940. In the example of FIG. 9, the peripheral data 925 illustrates an example of the interface circuitry 170 communicating with the bridge devices 115, 120 using inter-integrated circuit (I2C) protocol. However, the peripheral data 925 may be modified to support an alternative communication protocol, such as SPI, I3C, etc.

The data set 910 is a third portion of the configuration data 900, which provides update data for a portion of memory, such as one of the portions of memory 185, 190. The data set 910 is another example of the data sets 210, 215, 710, 715, 905. The example data set 910 of FIG. 9 includes the chunk header 250 and example chunk data 950. Similar to the chunk data 915, the example chunk data 950 of FIG. 9 includes a first example portion of chunk data 955, example peripheral data 960, and a second example portion of chunk data 965. The portions of chunk data 955, 965 are examples of the portions of chunk data 920, 930. Unlike the portions of chunk data 920, 930, the portions of chunk data 955, 965 correspond to the portion of memory of the chunk header 250.

Similar to the peripheral data 925, the peripheral data 960 is another command for one or more of the bridge devices 115, 120. The example peripheral data 960 of FIG. 9 includes an example peripheral device address 970, an example peripheral register address 975, and example peripheral write data 980. In the example of FIG. 9, the peripheral data 960 is structured for I2C communications between the interface circuitry 170 and the bridge devices 115, 120.

Advantageously, encoding the peripheral data 925, 960 into the chunk data 915, 950 allows the FDL decoder circuitry 180 to update the bridge devices 115, 120 during a firmware update. Advantageously, the FDL decoder circuitry 180 can continue to receive and write the portions of chunk data 920, 965 during the write operations of the interface circuitry 170. Advantageously, including the peripheral data 925, 960 in the configuration data 900 reduces the total time to update the firmware of the audio device 110 and the bridge devices 115, 120.

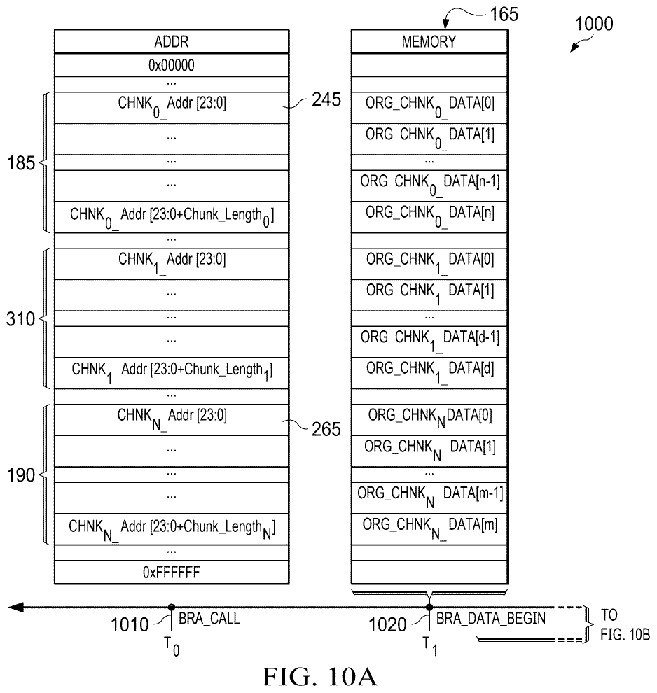

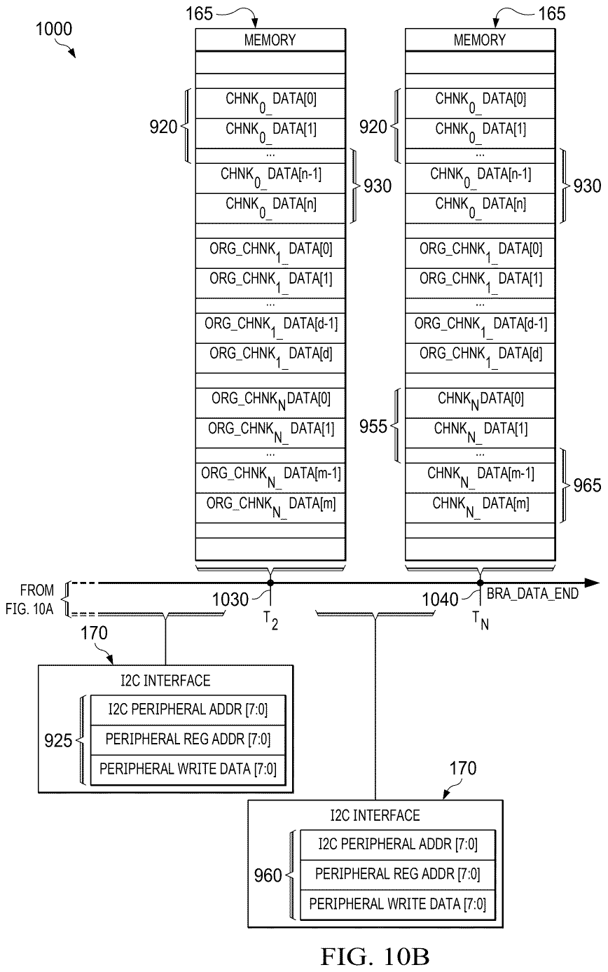

FIGS. 10A and 10B are a timing diagram 1000 of example operations of the FDL decoder circuitry 180 of FIGS. 1 and 5 to update firmware in the memory circuitry 165 using the configuration data 900 of FIG. 9, according to an embodiment of the present disclosure. In the example of FIGS. 10A and 10B, the memory circuitry 165 includes the portions of memory 185, 190, 310. As further described in connection with FIG. 3, each respective one of the portions of memory 185, 190, 310 span a plurality of consecutive memory addresses. However, in some examples, start or end memory addresses of the portions of memory 185, 190, 310 are non-consecutive in relation to each other. For example, a portion of memory can separate the last address of the portion of memory 185 and the start address of the portion of memory 310. Advantageously, the FDL decoder circuitry 180 can use the chunk headers 230, 250, 725, 765 to update non-consecutive memory addresses of the memory circuitry 165 without an additional BRA call command (BRA_CALL).

At a first time 1010 (T₀), the FDL circuitry 175 generates a BRA call command (BRA_CALL) to start a firmware update. At a second time 1020 (T₁), the host device 105 starts providing the BRA data stream (BRA_DATA) responsive to the BRA call command (BRA_CALL). The BRA data stream (BRA_DATA) provides the update data corresponding to the configuration data 900. At the time 1020, the portion of memory 185 contains first original chunk data (ORG_CHNK₀_DATA[n:0]), the portion of memory 310 contains second original chunk data (ORG_CHNK₁_DATA[d:0]), and the portion of memory 190 contains third original chunk data (ORG_CHNK_{N}_DATA[m:0]).

Between the second time 1020 and a third time 1030 (T₂), the FDL decoder circuitry 180 writes the first portion of chunk data 920 to the portion of memory 185. In such example operations, the FDL decoder circuitry 180 uses the start address 245 to identify an address in the portion of memory 185 to start writing the chunk data 915. In the example of FIG. 9, after receiving the portion of chunk data 920, the FDL decoder circuitry 180 receives the peripheral data 925. The FDL decoder circuitry 180 provides the peripheral data 925 to the interface circuitry 170 to begin updating the configuration of one or more of the bridge devices 115, 120. After providing the peripheral data 925 to the interface circuitry 170, the FDL decoder circuitry 180 continues by writing the portion of chunk data 930 to the memory circuitry 165. After the third time 1030 (T₂), the portion of memory 185 contains the portions of chunk data 920, 930 (CHNK₀_DATA[n:0]), the portion of memory 310 contains the original chunk data (ORG_CHNK₁_DATA[d:0]), and the portion of memory 190 contains the original chunk data (ORG_CHNK_{N}_DATA[m:0]).

Between the third time 1030 and a fourth time 1040 (T_{N}), the FDL decoder circuitry 180 writes the portion of chunk data 955 to the portion of memory 190. In such example operations, the FDL decoder circuitry 180 uses the start address 265 to identify an address in the portion of memory 190 to start writing the chunk data 950. In the example of FIG. 9, after receiving the portion of chunk data 955, the FDL decoder circuitry 180 receives the peripheral data 960. The FDL decoder circuitry 180 provides the peripheral data 960 to the interface circuitry 170 to begin updating the configuration of one or more of the bridge devices 115, 120. After providing the peripheral data 960 to the interface circuitry 170, the FDL decoder circuitry 180 continues by writing the portion of chunk data 965 to the memory circuitry 165. After the fourth time 1040 (T_{N}), the portion of memory 185 contains the portions of chunk data 920, 930 (CHNK₀_DATA[n:0]), the portion of memory 310 contains the original chunk data (ORG_CHNK₁_DATA[d:0]), and the portion of memory 190 contains the portions of chunk data 955, 965 (CHNK_{N}_DATA[m:0]).

Advantageously, between the times 1020, 1030 and the times 1030, 1040, the FDL decoder circuitry 180 can start configuring the bridge devices 115, 120 for the firmware update using the peripheral data 925, 960. Advantageously, providing the peripheral data 925, 960 between the portions of chunk data 920, 930, 955, 965 reduces the total time of the firmware update of the configuration data 900.

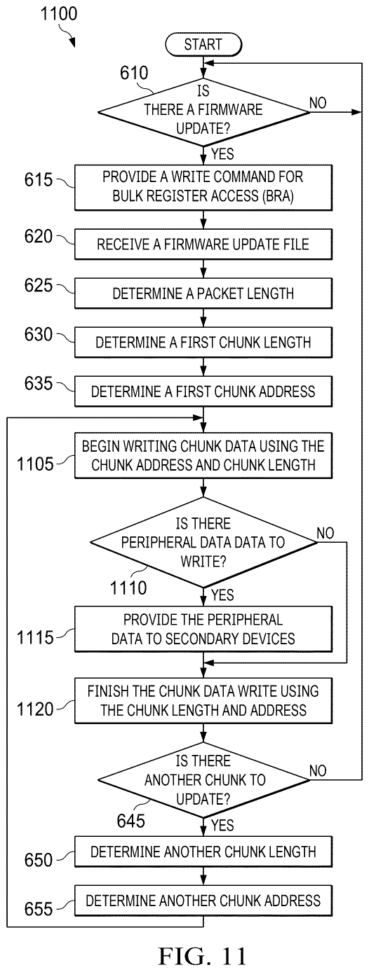

FIG. 11 is a flowchart of embodiment method 1100, according to an embodiment of the present disclosure. Method 1100 may be executed, instantiated, or performed using an example implementation of the FDL circuitry 175 of FIGS. 1 and 4 and the FDL decoder circuitry 180 of FIGS. 1 and 5 to update the firmware of the audio system 100 of FIG. 1 using the configuration data 900 of FIG. 9.

Method 1100 begins with the example operations of Blocks 610, 615, 620, 625, 630, 635. Control proceeds to Block 1105.

The chunk write circuitry 540 begins a chunk data write using the chunk address and chunk length. (Block 1105). In example operations, the chunk write circuitry 540 begins writing the portion of chunk data 920 to the chunk start address 245 in the memory circuitry 165. In such example operations, the chunk write circuitry 540 continues writing the portion of chunk data 920 to consecutive addresses of the memory circuitry 165.

The interface manager circuitry 550 determines if there is peripheral data to write. (Block 1110). In example operations, the interface manager circuitry 550 monitors the BRA data stream (BRA_DATA) for the peripheral data 925. In some examples, the peripheral data 925 is periodically positioned in the configuration data 900. For example, the configuration data 900 is structured to have an instance of the peripheral data 925 every two-hundred and fifty words of the chunk data 915. In such examples, the interface manager circuitry 550 monitors the BRA data stream (BRA_DATA) every two-hundred and fifty words for the peripheral data 925. In other examples, the configuration data 900 can include fixed data packets, such as the default data 750, 755, to identify the peripheral data 925.

If the interface manager circuitry 550 determines there is peripheral data to write (e.g., Block 1110 returns a result of YES), the interface manager circuitry 550 provides the peripheral data to secondary devices. (Block 1115). In example operations, the interface manager circuitry 550 uses the interface circuitry 170 to configure one or more of the bridge devices 115, 120 using the peripheral data 925. In some examples, such as in FIGS. 9, 10A, and 10B, the interface circuitry 170 uses I2C communication protocols to write the peripheral write data 945 to the register address 940 of the peripheral device address 935. In such example operations, the interface circuitry 170 uses the peripheral data 925 to generate write commands for the bridge devices 115, 120 without stopping the write of the chunk data 915 to the memory circuitry 165. Advantageously, the peripheral data 925 allows the FDL decoder circuitry 180 to sequence use of a second communication protocol during the firmware update of the configuration data 900.

If the interface manager circuitry 550 determines there is no peripheral data to write (e.g., Block 1110 returns a result of NO) or control proceeds from Block 1115, the chunk write circuitry 540 finishes the chunk data write using the chunk length and address. (Block 1120). In example operations, after providing the peripheral data 925 to the interface circuitry 170, the chunk write circuitry 540 proceeds by writing the portion of chunk data 930 to the memory circuitry 165. In some examples, the chunk write circuitry 540 determines the end of the chunk data 915 using the chunk data length 240. Control proceeds to the Blocks 645, 650, 655.

Example methods are described with reference to the flowchart illustrated in FIG. 11. However, many other methods of implementing the FDL circuitry 175 of FIGS. 1 and 4 and the FDL decoder circuitry 180 of FIGS. 1 and 5 to update the audio system 100 of FIG. 1 using the configuration data 900 of FIG. 9 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

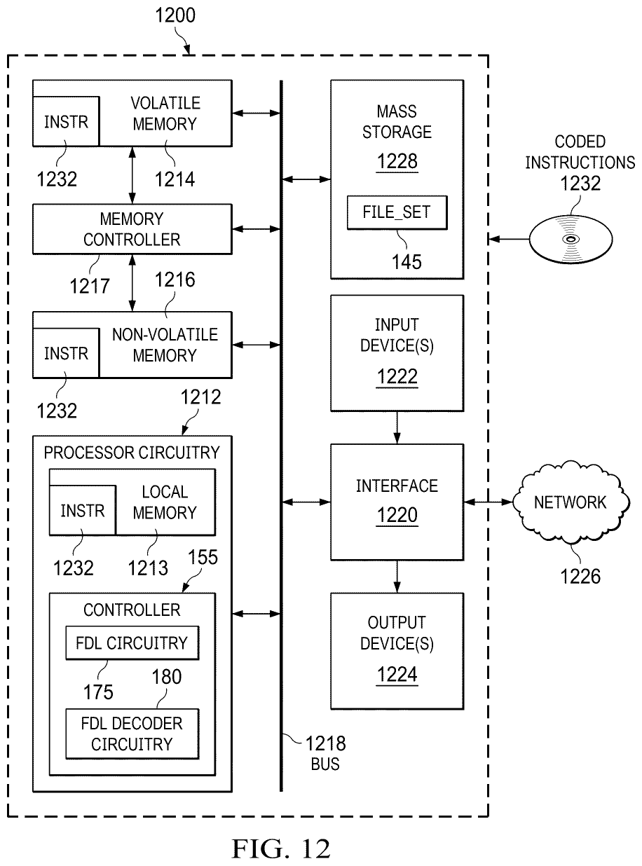

FIG. 12 is a block diagram of an example programmable circuitry platform 1200 structured to one or a combination of execute or instantiate one or more of the example machine-readable instructions or the example operations of FIGS. 6, 8, and 11 to implement the FDL circuitry 175 and the FDL decoder circuitry 180 of FIGS. 1, 4, and 5. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, DSPs, or microcontrollers from any desired family or manufacturer. The programmable circuitry 1212 may be implemented by one or more semiconductor based (e.g., silicon based) devices. In this example, the programmable circuitry 1212 implements the FDL circuitry 175 and the FDL decoder circuitry 180 or, more generally, the controller 155.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1216 may be implemented by one or a combination of flash memory or any other desired type of memory device. Access to the main memory 1214, 1216 of the illustrated examples is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter one of or a combination of data or commands into the programmable circuitry 1212. The input device(s) 1222 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1224 are also connected to the interface circuitry 1220 of the illustrated example. The output device(s) 1224 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1220 of the illustrated example, thus, includes one of or a combination of a graphics driver card, a graphics driver chip, or graphics processor circuitry such as a GPU.

The interface circuitry 1220 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store one or more of firmware, software, or data. Examples of such mass storage discs or devices 1228 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 1232, which may be implemented by the machine-readable instructions of FIGS. 6, 8, and 11, may be stored in one of or a combination of the mass storage device 1228, in the volatile memory 1214, in the non-volatile memory 1216, or on at least one non-transitory computer readable storage medium such as a CD or DVD which may be removable.

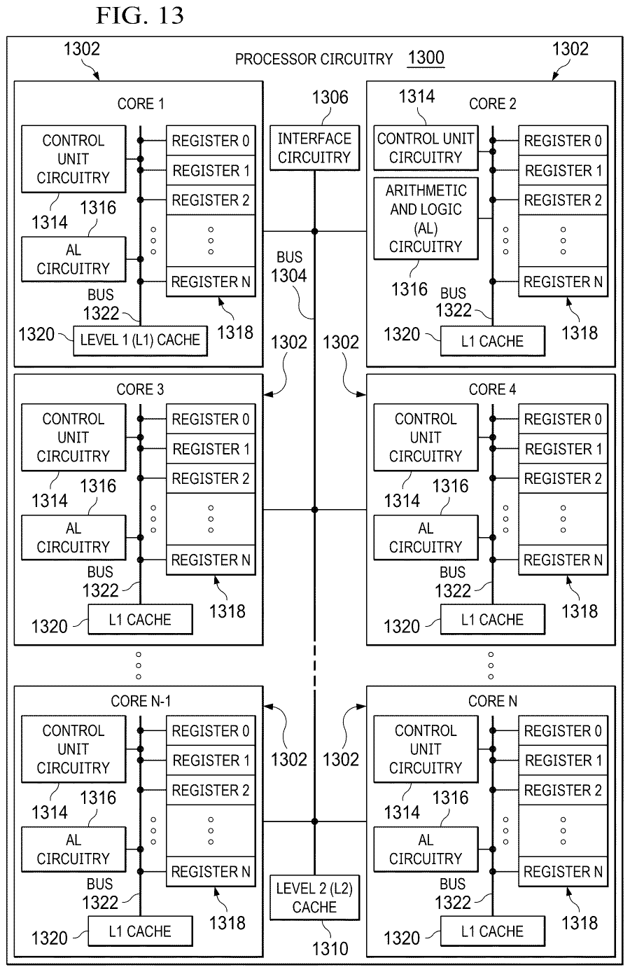

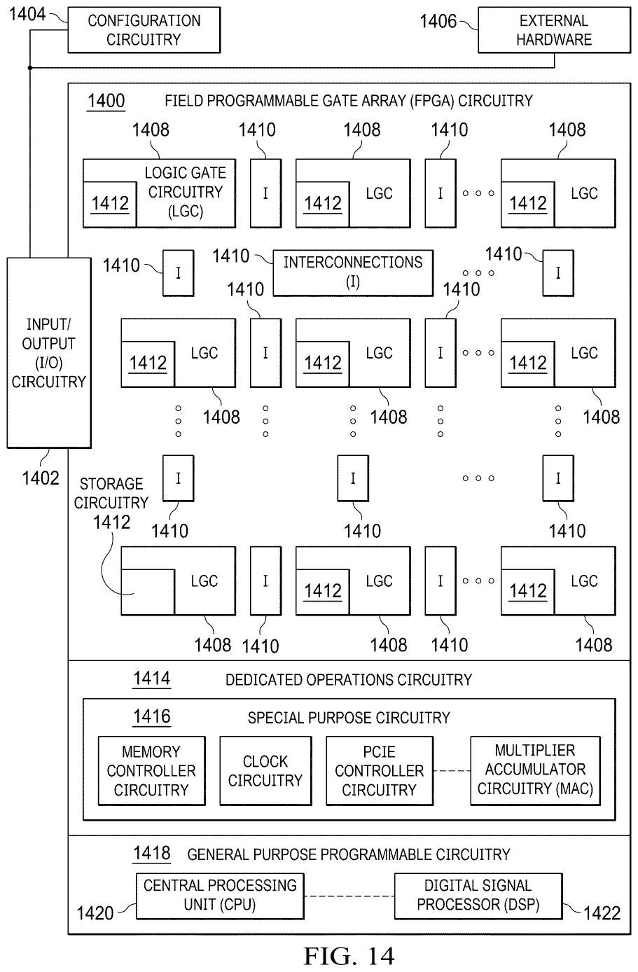

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIGS. 6, 8, and 11 to effectively instantiate the circuitry of FIGS. 4 and 5 as logic circuits to perform operations corresponding to those machine-readable instructions. In some such examples, the circuitry of FIGS. 1, 4, and 5 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine-readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine-readable instructions or operations represented by the flowcharts of FIGS. 6, 8, and 11.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Also or alternatively, the first bus 1304 may be implemented by any other type of computing or electrical bus. The cores 1302 may receive data, instructions, and signals from one or more external devices by example interface circuitry 1306. The cores 1302 may output data, instructions, and signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and instructions. Data and instructions may be transferred (e.g., shared) by one of or a combination of writing to or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). In some examples, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic or logic operations on the data within the corresponding core 1302. The AL circuitry 1316 of some examples performs integer-based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an I2C bus, a SPI bus, a PCI bus, or a PCIe bus.

Each core 1302 or, more generally, the microprocessor 1300 may include additional or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) or other circuitry may be present. The microprocessor 1300 is a semiconductor device fabricated to include many transistors interconnected to implement the structures described above in one or more integrated circuits (ICs) contained in one or more packages.

The microprocessor 1300 may include or cooperate with one or more accelerators (e.g., acceleration circuitry, hardware accelerators, etc.). In some examples, accelerators are implemented by logic circuitry to perform certain tasks more quickly and efficiently than can be done by a general-purpose processor. Examples of accelerators include ASICs and FPGAs such as those described herein. A GPU, DSP, or other programmable device can also be an accelerator. Accelerators may be on-board the microprocessor 1300, in the same chip package as the microprocessor 1300, or in one or more separate packages from the microprocessor 1300.

FIG. 14 is a block diagram of another example implementation of the programmable circuitry 1212 of FIG. 12. In this example, the programmable circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine-readable instructions. However, once configured, the FPGA circuitry 1400 instantiates the operations and functions corresponding to the machine-readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine-readable instructions represented by the flowchart(s) of FIGS. 6, 8, and 11 but whose interconnections and logic circuitry are fixed once fabricated), the FPGA circuitry 1400 of the example of FIG. 14 includes interconnections and logic circuitry that may be one of or a combination of configured, structured, programmed, and interconnected in different ways after fabrication to instantiate, for example, some or all of the operations/functions corresponding to the machine-readable instructions represented by the flowchart(s) of FIGS. 6, 8, and 11. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6, 8, and 11. As such, the FPGA circuitry 1400 may be at least one of configured or structured to effectively instantiate some or all of the operations/functions corresponding to the machine-readable instructions of the flowchart(s) of FIGS. 6, 8, and 11 as dedicated logic circuits to perform the operations/functions corresponding to those software instructions in a dedicated manner analogous to an ASIC. Therefore, the FPGA circuitry 1400 may perform the operations/functions corresponding to the some or all of the machine-readable instructions of FIGS. 6, 8, and 11 faster than the general-purpose microprocessor can execute the same.

In the example of FIG. 14, the FPGA circuitry 1400 is at least one of configured or structured in response to being programmed (and/or reprogrammed one or more times) based on a binary file. In some examples, the binary file may be one of or both of compiled or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may at least one of access or load the binary file to cause the FPGA circuitry 1400 of FIG. 14 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1400 of FIG. 14 to at least one of configure or structure the FPGA circuitry 1400 of FIG. 14, or portion(s) thereof.

In some examples, the binary file is at least one of compiled, generated, transformed, or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is at least one of compiled, generated, or otherwise output from the uniform software platform based on the second instructions. In some examples, the FPGA circuitry 1400 of FIG. 14 may at least one of access or load the binary file to cause the FPGA circuitry 1400 of FIG. 14 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1400 of FIG. 14 to at least one of configure or structure the FPGA circuitry 1400 of FIG. 14, or portion(s) thereof.

The FPGA circuitry 1400 of FIG. 14, includes example input/output (I/O) circuitry 1402 to at least one of receive or output data to/from at least one of example configuration circuitry 1404 or external hardware 1406. For example, the configuration circuitry 1404 may be implemented by interface circuitry that may receive a binary file, which may be implemented by one or more of a bit stream, data, or machine-readable instructions, to configure the FPGA circuitry 1400, or portion(s) thereof. In some such examples, the configuration circuitry 1404 may receive the binary file from one of or a combination of a user, a machine (e.g., hardware circuitry (e.g., programmable or dedicated circuitry) that may implement an Artificial Intelligence/Machine Learning (AI/ML) model to generate the binary file, etc.), or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine-readable instructions of FIGS. 6, 8, and 11 and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of one of or a combination of the electrical structures or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 or an example DSP 1422. Other general purpose programmable circuitry 1418 may also or alternatively be present such as a GPU, an XPU, etc., that can be programmed to perform other operations.

Although FIGS. 13 and 14 illustrate two example implementations of the programmable circuitry 1212 of FIG. 12, many other approaches are contemplated. For example, FPGA circuitry may include an on-board CPU, such as one or more of the example CPU 1420 of FIG. 13. Therefore, the programmable circuitry 1212 of FIG. 12 may also be implemented by combining at least the example microprocessor 1300 of FIG. 13 and the example FPGA circuitry 1400 of FIG. 14. In some such hybrid examples, one or more cores 1302 of FIG. 13 may execute a first portion of the machine-readable instructions represented by the flowchart(s) of FIGS. 6, 8, and 11 to perform first operation(s)/function(s), the FPGA circuitry 1400 of FIG. 14 may be at least one of configured or structured to perform second operation(s)/function(s) corresponding to a second portion of the machine-readable instructions represented by the flowcharts of FIGS. 6, 8, and 11, and/or an ASIC may be at least one of configured or structured to perform third operation(s)/function(s) corresponding to a third portion of the machine-readable instructions represented by the flowcharts of FIGS. 6, 8, and 11.

Some or all of the circuitry of FIGS. 1, 4, and 5 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be at least one of configured or structured to perform operations/functions corresponding to portion(s) of machine-readable instructions at the same and/or different times.

In some examples, some or all of the circuitry of FIGS. 1, 4, and 5 may be instantiated, for example, in one or more threads executing concurrently and/or in series. For example, the microprocessor 1300 of FIG. 13 may execute machine-readable instructions in one or more threads executing concurrently and/or in series. In some examples, the FPGA circuitry 1400 of FIG. 14 may be at least one of configured or structured to carry out operations/functions concurrently and/or in series. Moreover, in some examples, some or all of the circuitry of FIGS. 1, 4, and 5 may be implemented within one or more virtual machines or containers executing on the microprocessor 1300 of FIG. 13.

In some examples, the programmable circuitry 1212 of FIG. 12 may be in one or more packages. For example, at least one of the microprocessor 1300 of FIG. 13 or the FPGA circuitry 1400 of FIG. 14 may be in one or more packages. In some examples, an XPU may be implemented by the programmable circuitry 1212 of FIG. 12, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

While an example manner of implementing the FDL circuitry 175 and the FDL decoder circuitry 180 of FIG. 1 is illustrated in FIGS. 1, 4, and 5, one or more of the elements, processes, or devices illustrated in FIGS. 1, 4, and 5 may be combined, divided, re-arranged, omitted, eliminated, or implemented in any other way. Further, the FDL circuitry 175 and the FDL decoder circuitry 180 or, more generally, the controller 155, may be implemented by hardware alone or by hardware in combination with software and firmware. Thus, for example, any of the FDL circuitry 175 and the FDL decoder circuitry 180 or, more generally, the controller 155, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example FDL circuitry 175 and the FDL decoder circuitry 180 of FIGS. 1, 4, and 5 may include one or more elements, processes, or devices in addition to, or instead of, those illustrated in FIGS. 1, 4, and 5, or may include more than one of any or all of the illustrated elements, processes and devices.

Flowchart(s) representative of example machine-readable instructions, which may be executed by programmable circuitry to at least one of implement or instantiate the FDL circuitry 175 and the FDL decoder circuitry 180 of FIGS. 1, 4, and 5 or representative of example operations which may be performed by programmable circuitry to at least one of implement or instantiate the FDL circuitry 175 and the FDL decoder circuitry 180 of FIGS. 1, 4, and 5, are shown in FIGS. 6, 8, and 11. The machine-readable instructions may be one or more executable programs or portion(s) of one or more executable programs for execution by programmable circuitry such as the programmable circuitry 1212 shown in the example processor platform 1200 described below in connection with FIG. 12 and may be one or more function(s) or portion(s) of functions to be performed by the example programmable circuitry (e.g., an FPGA) described below in connection with FIG. 13 or 14. In some examples, the machine-readable instructions cause an operation, a task, etc., to be carried out or performed in an automated manner in the real-world. As used herein, “automated” means without human involvement.

The program may be embodied in instructions (e.g., software and/or firmware) stored on one or more non-transitory computer readable and/or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable and/or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6, 8, and 11, many other methods of implementing the example FDL circuitry 175 and the FDL decoder circuitry 180 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, one of or a combination of a CPU or an FPGA. The programmable circuitry may include one or more CPUs and/or one or more FPGAs located in the same package (e.g., the same integrated circuit (IC) package or in two or more separate housings), one or more CPUs or FPGAs in a single machine, one or multiple CPUs or FPGAs distributed across multiple servers of a server rack, multiple processors distributed across one or more server racks. Also or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., or any combination(s) thereof in any of the contexts described above.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 6, 8, and 11 may be implemented using executable instructions (e.g., computer readable and/or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

Example embodiments of the present disclosure are summarized here. Other embodiments can also be understood from the entirety of the specification and the claims filed herein.

Example 1. A device including: memory circuitry having a first memory portion and a second memory portion, the first memory portion corresponding to a first range of memory addresses, the second memory portion corresponding to a second range of memory addresses, where the first range of memory addresses are non-consecutive to the second range of memory addresses; and a controller coupled to the memory circuitry, the controller configured to: request first data; after requesting the first data, receive the first data in a packet having a first data set and a second data set, the first data set including a first chunk start address corresponding to an address of the first range of memory addresses, the second data set including a second chunk start address corresponding to an address of the second range of memory address; write data of the first data set to the first memory portion using the first chunk start address; and write data of the second data set to the second memory portion using the second chunk start address.

Example 2. The device of example 1, where the packet includes a header that includes a payload length field, and a payload including the first and second data sets.

Example 3. The device of one of examples 1 or 2, where the memory circuitry further includes a third memory portion corresponding to a third range of memory addresses, the first and third ranges of memory addresses being consecutive addresses, and the second and third ranges of memory addresses being consecutive addresses.

Example 4. The device of one of examples 1 to 3, where to request the first data, the controller is configured to: generate a bulk register access (BRA) call command; and provide the BRA call command to a host device.

Example 5. The device of one of examples 1 to 4, further including a host device coupled to the controller, the host device configured to, after receiving the BRA call, provide the first data including the first data set and the second data set using SoundWire protocols.

Example 6. The device of one of examples 1 to 5, where the data of the first data set includes chunk data, where the first data set further includes a chunk header, the chunk header including the first chunk start address, where the first chunk start address corresponds to the start address in the first range of addresses of the first memory portion.

Example 7. The device of one of examples 1 to 6, where the chunk header further includes a chunk start address, the chunk start address corresponds to the start address in the first range of addresses of the first memory portion, and the controller is further configured to write the chunk data of the first data set beginning at the chunk start address.

Example 8. The device of one of examples 1 to 7, where the data of the first data set includes chunk data, where the first data set further includes cyclic redundancy check (CRC) data, and the controller is further configured to verify the write of the chunk data to the first memory portion using the CRC data.

Example 9. The device of one of examples 1 to 8, where the CRC data includes a CRC value and default data, and the controller further configured to: calculate a real-time CRC value using the write of the first data set; compare the real-time CRC value to the CRC value; and after determining the real-time CRC value is equal to the CRC value, compare subsequent data of the first data set to the default data; and after determining the default data matches reference data, determine that the write of the first data set is successful.

Example 10. The device of one of examples 1 to 9, where the first data set further includes a first portion, peripheral data, and a second portion, the device further including: a bridge device coupled to the controller; and where the controller is further configured to: after writing the first portion of the first data set to the first memory portion, write the peripheral data to the bridge device; and write the second portion of the data of the first data set to the first memory portion.

Example 11. The device of one of examples 1 to 10, where the controller is configured to write the second portion of the data of the first data set to the first memory portion after writing the peripheral data to the bridge device.

Example 12. The device of one of examples 1 to 11, where the controller is configured to write at least a portion of the second portion of the data of the first data set to the first memory portion while writing the peripheral data to the bridge device.

Example 13. The device of one of examples 1 to 12, where the controller writes the peripheral data to the bridge device using an inter-integrated circuit (I2C) protocol.

Example 14. The device of one of examples 1 to 13, further including a speaker or microphone coupled to the bridge device.

Example 15. A method including: requesting, by a first device, first data using a first protocol; after requesting the first data, receiving, by the first device, a packet including the first data using the first protocol, the first data having a first data set and a second data set, the first data set including peripheral data, the second data set including a chunk start address corresponding to an address of a first portion of memory; writing, by the first device, a first portion of the first data set to a second portion of memory; after writing the first portion of the first data set, providing, by the first device, the peripheral data to a second device using a second protocol; after writing the first portion of the first data set, writing, by the first device, a second portion of the first data set to the second portion of memory; and after writing the second portion of the first data set, writing data of the second data set to the first portion of memory using the chunk start address of the second data set.

Example 16. The method of example 15, where providing the peripheral data to the second device occurs while receiving, by the first device, the packet.

Example 17. The method of one of examples 15 or 16, where providing the peripheral data to the second device occurs while receiving, by the first device, at least a portion of the second data set.

Example 18. The method of one of examples 15 to 17, where the first data includes first configuration data for the first device, the method further including, after receiving the first data, receiving audio data via the first protocol.

Example 19. The method of one of examples 15 to 18, where the first data includes second configuration data for the second device.

Example 20. The method of one of examples 15 to 19, further including configuring the second device, and a third device, using the second configuration data.

Example 21. The method of one of examples 15 to 20, where the requesting for first data includes: generating a bulk register addressing (BRA) call command; and providing the BRA call command to a host device having the first data.

Example 22. The method of one of examples 15 to 21, where the first protocol is SoundWire and the second protocol is inter-integrated circuit (I2C).

Example 23. The method of one of examples 15 to 22, where the peripheral data includes peripheral device commands and the second device is a bridge device supporting at least one of a microphone or speaker.

Example 24. The method of one of examples 15 to 23, where the first data set further includes cyclic redundancy check (CRC) data, the method further including, verifying the write of the first and second portions of the first data set using the CRC data.

Example 25. The method of one of examples 15 to 24, where the CRC data includes a CRC value and default data, and the method further including: calculating a real-time CRC value using the write of the first data set; comparing the real-time CRC value to the CRC value; and after determining the real-time CRC value is equal to the CRC value, comparing subsequent data of the first data set to the default data; and after determining the default data matches reference data, determining the write of the first data set is successful.

Example 26. A device including: memory circuitry having a first memory portion, a second memory portion, and a third memory portion, the first memory portion corresponding to a first range of memory addresses, the second memory portion corresponding to a second range of memory addresses, the third memory portion corresponding to a third range of memory addresses, where the first and second ranges of memory addresses are consecutive addresses, and where the second and third ranges of memory addresses are consecutive addresses; and a controller coupled to the memory circuitry, the controller configured to: request configuration data; after requesting the configuration data, receive the configuration data having a first data set and a second data set, the first data set including a first memory address in the first range of memory addresses, the second data set including a second memory address of in the third range of memory addresses; write data of the first data set to the first memory portion using the first memory address; and write data of the second data set to the third memory portion using the second memory address.

Example 27. The device of example 26, where the configuration data includes configuration data for configuring the device.

Example 28. The device of one of examples 26 or 27, where the requesting for update data includes: generating a bulk register addressing (BRA) call command; and providing the BRA call command to a host device having the first data.

Example 29. The device of one of examples 26 to 28, where the first data set includes chunk data, the first data set further includes cyclic redundancy check (CRC) data, and the controller is further configured to verify the write of the chunk data to the first memory portion using the CRC data.

Example 30. The device of one of examples 26 to 29, where the CRC data includes a CRC value and default data, and the controller further configured to: calculate a real-time CRC value using the write of the first data set; compare the real-time CRC value to the CRC value; and after determining the real-time CRC value is equal to the CRC value, compare subsequent data of the first data set to the default data; and after determining the default data matches reference data, determine the write of the first data set is successful.

Example 31. The device of one of examples 26 to 30, where the first data set further includes a first portion, peripheral data, and a second portion, and the device further including: a bridge device coupled to the controller; and where the controller is further configured to: after writing the first portion of the first data set to the first memory portion, write the peripheral data to the bridge device; and write the second portion of the first data set to the first memory portion.

Example 32. An electronic device including: a primary device; a secondary device; and an audio device coupled to the primary device and the secondary device, the audio device configured to: receive an update using a first communication protocol, the update having a first data set and a second data set, the update corresponding to operations of the secondary device; write data of the first data set to a first portion of memory, the first portion of memory corresponding to first operations of the secondary device; and write data of the second data set to a second portion of memory, the second portion of memory corresponding to second operations of the secondary device, the first and second portions of memory have non-consecutive memory addresses.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” may include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Modifications are possible in the described embodiments, and other embodiments are possible, within the scope of the claims.

What is claimed is:

1. A device comprising:
memory circuitry having a first memory portion and a second memory portion, the first memory portion corresponding to a first range of memory addresses, the second memory portion corresponding to a second range of memory addresses, wherein the first range of memory addresses are non-consecutive to the second range of memory addresses; and
a controller coupled to the memory circuitry, the controller configured to:
request first data;
after requesting the first data, receive the first data in a packet having a first data set and a second data set, the first data set including a first chunk start address corresponding to an address of the first range of memory addresses, the second data set including a second chunk start address corresponding to an address of the second range of memory address;
write data of the first data set to the first memory portion using the first chunk start address; and
write data of the second data set to the second memory portion using the second chunk start address.

2. The device of claim 1, wherein the packet comprises a header that comprises a payload length field, and a payload comprising the first and second data sets.

3. The device of claim 1, wherein the memory circuitry further includes a third memory portion corresponding to a third range of memory addresses, the first and third ranges of memory addresses being consecutive addresses, and the second and third ranges of memory addresses being consecutive addresses.

4. The device of claim 1, wherein to request the first data, the controller is configured to:
generate a bulk register access (BRA) call command; and
provide the BRA call command to a host device.

5. The device of claim 4, further comprising a host device coupled to the controller, the host device configured to, after receiving the BRA call, provide the first data including the first data set and the second data set using SoundWire protocols.

6. The device of claim 1, wherein the data of the first data set comprises chunk data, wherein the first data set further includes a chunk header, the chunk header including the first chunk start address, wherein the first chunk start address corresponds to the start address in the first range of addresses of the first memory portion.

7. The device of claim 6, wherein the chunk header further includes a chunk start address, the chunk start address corresponds to the start address in the first range of addresses of the first memory portion, and the controller is further configured to write the chunk data of the first data set beginning at the chunk start address.

8. The device of claim 1, wherein the data of the first data set comprises chunk data, wherein the first data set further includes cyclic redundancy check (CRC) data, and the controller is further configured to verify the write of the chunk data to the first memory portion using the CRC data.

9. The device of claim 8, wherein the CRC data includes a CRC value and default data, and the controller further configured to:
calculate a real-time CRC value using the write of the first data set;
compare the real-time CRC value to the CRC value; and
after determining the real-time CRC value is equal to the CRC value, compare subsequent data of the first data set to the default data; and
after determining the default data matches reference data, determine that the write of the first data set is successful.

10. The device of claim 1, wherein the first data set further includes a first portion, peripheral data, and a second portion, the device further comprising:
a bridge device coupled to the controller; and
wherein the controller is further configured to:
after writing the first portion of the first data set to the first memory portion, write the peripheral data to the bridge device; and
write the second portion of the data of the first data set to the first memory portion.

11. The device of claim 10, wherein the controller is configured to write the second portion of the data of the first data set to the first memory portion after writing the peripheral data to the bridge device.

12. The device of claim 10, wherein the controller is configured to write at least a portion of the second portion of the data of the first data set to the first memory portion while writing the peripheral data to the bridge device.

13. The device of claim 10, wherein the controller writes the peripheral data to the bridge device using an inter-integrated circuit (I2C) protocol.

14. The device of claim 10, further comprising a speaker or microphone coupled to the bridge device.

15. A method comprising:
requesting, by a first device, first data using a first protocol;
after requesting the first data, receiving, by the first device, a packet comprising the first data using the first protocol, the first data having a first data set and a second data set, the first data set including peripheral data, the second data set including a chunk start address corresponding to an address of a first portion of memory;
writing, by the first device, a first portion of the first data set to a second portion of memory;
after writing the first portion of the first data set, providing, by the first device, the peripheral data to a second device using a second protocol;
after writing the first portion of the first data set, writing, by the first device, a second portion of the first data set to the second portion of memory; and
after writing the second portion of the first data set, writing data of the second data set to the first portion of memory using the chunk start address of the second data set.

16. The method of claim 15, wherein providing the peripheral data to the second device occurs while receiving, by the first device, the packet.

17. The method of claim 15, wherein providing the peripheral data to the second device occurs while receiving, by the first device, at least a portion of the second data set.

18. The method of claim 15, wherein the first data comprises first configuration data for the first device, the method further comprising, after receiving the first data, receiving audio data via the first protocol.

19. The method of claim 18, wherein the first data comprises second configuration data for the second device.

20. The method of claim 19, further comprising configuring the second device, and a third device, using the second configuration data.

21. The method of claim 15, wherein the requesting for first data includes:
generating a bulk register addressing (BRA) call command; and
providing the BRA call command to a host device having the first data.

22. The method of claim 15, wherein the first protocol is SoundWire and the second protocol is inter-integrated circuit (I2C).

23. The method of claim 15, wherein the peripheral data includes peripheral device commands and the second device is a bridge device supporting at least one of a microphone or speaker.

24. The method of claim 15, wherein the first data set further includes cyclic redundancy check (CRC) data, the method further comprising, verifying the write of the first and second portions of the first data set using the CRC data.

25. The method of claim 24, wherein the CRC data includes a CRC value and default data, and the method further comprising:
calculating a real-time CRC value using the write of the first data set;
comparing the real-time CRC value to the CRC value; and
after determining the real-time CRC value is equal to the CRC value, comparing subsequent data of the first data set to the default data; and
after determining the default data matches reference data, determining the write of the first data set is successful.
